(19) United States
(12) Patent Application Publication
(10) Pub. No.: US 2026/0336328 A1
(43) Pub. Date: Oct. 29, 2026

(54) TIRE

(71) Applicant: THE YOKOHAMA RUBBER CO., LTD., Kanagawa (JP)

(72) Inventor: Haruka ARAI, Kanagawa (JP)

(21) Appl. No.: 19/104,050

(22) PCT Filed: Apr. 5, 2023
(86) PCT No.: PCT/JP2023/014132

§ 371 Date: Feb. 14, 2025

(30) Foreign Application Priority Data
Aug. 22, 2022 (JP) 2022-132026

(51) Int. Cl. B60C 3/04; B60C 9/00

(52) U.S. Cl. CPC B60C 3/04; B60C 2009/0035; B60C 2009/0071

(57) ABSTRACT

In a tire, a point (Au) on a side profile at the same position in a radial direction as an end portion of an innermost layer of a belt layer is defined in a cross-sectional view in a meridian direction. A foot of a perpendicular line drawn from the point (Au) to the carcass layer is defined as a point (Iu), and a foot of a perpendicular line drawn from the maximum width position (Ac) to the carcass layer is defined as a point (Ic). The carcass layer is composed of one or more carcass plies formed by covering a carcass cord with a coating rubber. A distance (TLu) (mm) from a carcass ply innermost layer carcass cord center to a inner surface in a region from the point (Iu) to the point (Ic) with respect to the outer diameter (OD) (mm) is in the range 0.00010≤TLu/OD≤0.01500.

### TECHNICAL FIELD

The technology relates to a tire and particularly relates to a tire that can provide durability performance and low rolling resistance performance of the tire in a compatible manner.

### BACKGROUND ART

In recent years, there has been developed a small-diameter tire to be mounted on a vehicle in which a floor is lowered to expand a vehicle interior space. For such a small-diameter tire, since rotational inertia is small and a tire weight is also small, a reduction in transportation cost is expected. On the other hand, the small-diameter tire is required to have a high load capacity. Technology described in International Patent Application Publication No. WO 2020/122169 is a known tire in the related art associated with such a problem.

### SUMMARY OF TECHNOLOGY

### Technical Problem

The technology provides a tire that can provide durability performance and low rolling resistance performance of the tire in a compatible manner.

A tire according to an aspect of the technology includes: a pair of bead cores; a carcass layer extending between the bead cores; a belt layer disposed on an outer side of the carcass layer in a radial direction; and an innerliner disposed on an inner surface of the carcass layer. A tire outer diameter OD (mm) is in a range 200≤OD≤660, and a total tire width SW (mm) is in a range 100≤SW≤400. In a cross-sectional view in a tire meridian direction, a point Au on a side profile at a position in a tire radial direction identical to an end portion of an innermost layer of the belt layer is defined, a foot of a perpendicular line drawn from the point Au to the carcass layer is defined as a point Iu, and a foot of a perpendicular line drawn from a tire maximum width position Ac to the carcass layer is defined as a point Ic. The carcass layer is composed of a single carcass ply or a plurality of carcass plies formed by covering a carcass cord with a coating rubber, and a distance TLu (mm) from a center of the carcass cord of an innermost layer of the carcass ply to a tire inner surface in a region from the point Iu to the point Ic with respect to the tire outer diameter OD (mm) is in a range 0.00010≤TLu/OD≤0.01500.

The tire according to the technology has an advantage that the distance from the carcass layer to the tire inner surface in the region from the end portion of the belt layer to the tire maximum width position is properly set. Specifically, the lower limit ensures the distance TLu from the carcass layer to the tire inner surface in the region in which air leakage is likely to occur, and suppresses a deterioration of the durability performance and a deterioration of the rolling resistance of the tire due to air leakage. The upper limit suppresses a deterioration of the rolling resistance caused by the increase in tire weight. This provides the durability performance and the low rolling resistance performance of the tire in a compatible manner. In particular, for a small-diameter tire, since the tire is used under the high internal pressure and the high load described above, stress concentration tends to occur. Therefore, by adopting the above-described configuration for the small-diameter tire, the effect of improving the durability performance and low rolling resistance performance of the tire is significantly obtained.

### BRIEF DESCRIPTION OF DRAWINGS

FIG. 1 is a cross-sectional view in a tire meridian direction illustrating a tire according to an embodiment of the technology.

FIG. 2 is an enlarged view illustrating the tire illustrated in FIG. 1.

FIG. 3 is an explanatory diagram illustrating a multilayer structure of a belt layer of the tire illustrated in FIG. 1.

FIG. 4 is an enlarged view illustrating a tread portion of the tire illustrated in FIG. 1.

FIG. 5 is an enlarged view illustrating a half region of the tread portion illustrated in FIG. 4.

FIG. 6 is an enlarged view illustrating a sidewall portion and a bead portion of the tire illustrated in FIG. 1.

FIG. 7 is an enlarged view illustrating the sidewall portion illustrated in FIG. 6.

FIG. 8 is an explanatory diagram illustrating a multilayer structure of a carcass layer and a belt layer of the tire illustrated in FIG. 1.

FIG. 9 is an explanatory diagram illustrating a modified example of the multilayer structure of the carcass layer and the belt layer illustrated in FIG. 8.

FIG. 10 is an explanatory diagram illustrating a modified example of the multilayer structure of the carcass layer and the belt layer illustrated in FIG. 8.

FIG. 11 is an enlarged view illustrating a region on an outer side in the tire radial direction illustrated in FIG. 6.

FIG. 12 is an explanatory diagram illustrating a multilayer structure of a carcass layer and an innerliner in the region on the outer side in the tire radial direction illustrated in FIG. 11.

FIG. 13 is a table showing results of performance tests of tires according to embodiments of the technology.

FIG. 14 is a table showing results of performance tests of tires according to embodiments of the technology.

FIG. 15 is a table showing results of performance tests of tires according to embodiments of the technology.

### DETAILED DESCRIPTION

Embodiments of the technology will be described in detail below with reference to the drawings. Note that the technology is not limited to the embodiments. Constituents of the embodiments include constituents that are substitutable and are obviously substitutes while maintaining consistency with the embodiments of the technology. A plurality of modified examples described in the embodiments can be combined in a discretionary manner within the scope apparent to one skilled in the art.

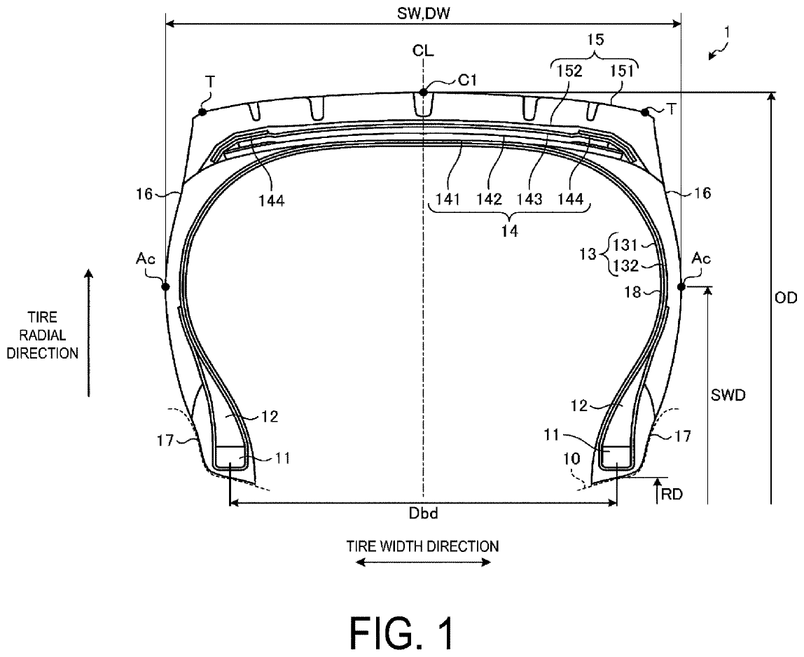

FIG. 1 is a cross-sectional view in a tire meridian direction illustrating a tire 1 according to an embodiment of the technology. The same drawing illustrates a cross-sectional view of a half region of the tire 1 mounted on a rim 10 in a tire radial direction. In this embodiment, a pneumatic radial tire for use on passenger cars will be described as an example of the tire.

In the same drawing, a cross-section in the tire meridian direction is defined as a cross-section of the tire taken along a plane that includes a tire rotation axis (not illustrated). A tire equatorial plane CL is defined as a plane that passes through a midpoint of a tire cross-sectional width DW specified by the Japan Automobile Tyre Manufacturers Association, Inc. (JATMA) and that is perpendicular to the tire rotation axis. A tire width direction is defined as a direction parallel to the tire rotation axis, and the tire radial direction is defined as a direction perpendicular to the tire rotation axis. A point T is a tire ground contact edge, and a point Ac is a tire maximum width position.

The tire 1 has an annular structure with the tire rotation axis serving as the center, and includes a pair of bead cores 11, 11, a pair of bead fillers 12, 12, a carcass layer 13, a belt layer 14, a tread rubber 15, a pair of sidewall rubbers 16, 16, a pair of rim cushion rubbers 17, 17, and an innerliner 18 (see FIG. 1).

The pair of bead cores 11, 11 respectively includes one or a plurality of bead wires made of steel and wound in an annular shape a plurality of times, is embedded in bead portions, and constitutes cores of the left and right bead portions. The pair of bead fillers 12, 12 is respectively disposed on an outer circumference of the pair of bead cores 11, 11 in the tire radial direction and reinforces the bead portions. The bead filler 12 has a rubber hardness Hs_bf of 55 or more and 105 or less, a modulus M_bf (MPa) at 100% elongation of 2.0 or more and 13.0 or less, and a loss tangent tan δ_bf of 0.03 or more and 0.30 or less and preferably the rubber hardness Hs_bf of 70 or more and 100 or less, the modulus M_bf (MPa) at 100% elongation of 3.0 or more and 12.0 or less, and the loss tangent tand_bf of 0.05 or more and 0.25 or less.

The carcass layer 13 has a single layer structure including one carcass ply or a multilayer structure including a plurality of carcass plies layered, extends in a toroidal shape between the left and right bead cores 11, 11, and constitutes the backbone of the tire. Both end portions of the carcass layer 13 are turned back toward outer sides in the tire width direction and fixed to wrap the bead cores 11 and the bead fillers 12. The carcass ply of the carcass layer 13 is made by covering a plurality of carcass cords made of inorganic fiber (for example, steel, carbon fiber, glass fiber) or an organic fiber material (for example, aramid, nylon, polyester, rayon, or the like) with a coating rubber and performing a rolling process on the carcass cords, and has a cord angle (defined as an inclination angle of the carcass cords in a longitudinal direction with respect to a tire circumferential direction) of 80 degrees or more and 100 degrees or less.

The belt layer 14 is made of a plurality of belt plies 141 to 144 layered and is disposed around an outer circumference of the carcass layer 13. In the configuration of FIG. 1, the belt plies 141 to 144 are constituted by a pair of cross belts 141, 142, a belt cover 143, and a pair of belt edge covers 144, 144.

The pair of cross belts 141, 142 is made by covering a plurality of belt cords made of steel or an organic fiber material with a coating rubber and performing a rolling process on the belt cords, and has a cord angle (defined as an inclination angle of the belt cords in a longitudinal direction with respect to the tire circumferential direction) of 15 degrees or more and 55 degrees or less as an absolute value. The pair of cross belts 141, 142 has cord angles having mutually opposite reference signs and is layered by making the belt cords intersect with each other in the longitudinal direction of the belt cords (a so-called crossply structure). The pair of cross belts 141, 142 is disposed in a layered manner on an outer side of the carcass layer 13 in the tire radial direction.

The belt cover 143 and the pair of belt edge covers 144, 144 are made by covering belt cover cords made of steel or an organic fiber material with a coating rubber and has a cord angle of 0 degree or more and 10 degrees or less as an absolute value. For example, a strip material is formed of one or a plurality of belt cover cords covered with coating rubber, and the belt cover 143 and the belt edge covers 144 are made by winding this strip material multiple times and in a spiral-like manner in the tire circumferential direction around outer circumferential surfaces of the cross belts 141, 142. The belt cover 143 is disposed completely covering the cross belts 141, 142, and the pair of belt edge covers 144, 144 is disposed covering the left and right edge portions of the cross belts 141, 142 from the outer side in the tire radial direction.

The tread rubber 15 is disposed on an outer circumference of the carcass layer 13 and the belt layer 14 in the tire radial direction and constitutes a tread portion of the tire 1. The tread rubber 15 includes a cap tread 151 and an undertread 152.

The cap tread 151 is made of a rubber material that is excellent in ground contact characteristics and weather resistance, is exposed in a tread surface all across a tire ground contact surface, and constitutes an outer surface of the tread portion. The cap tread 151 has a rubber hardness Hs_cap of 50 or more and 80 or less, a modulus M_cap (MPa) at 100% elongation of 1.0 or more and 4.0 or less, and a loss tangent tand_cap of 0.03 or more and 0.36 or less and preferably the rubber hardness Hs_cap of 58 or more and 76 or less, the modulus M_cap (MPa) at 100% elongation of 1.5 or more and 3.2 or less, and the loss tangent tan δ_cap of 0.06 or more and 0.29 or less.

The rubber hardness Hs is measured in accordance with JIS (Japanese Industrial Standard) K6253 at a temperature condition of 20 °C.

The modulus (strength at break) is measured by a tensile test at a temperature of 20 °C with a dumbbell-shaped test piece in accordance with JIS K6251 (using a number 3 dumbbell).

The loss tangent tand is measured by using a viscoelasticity spectrometer available from Toyo Seiki Seisaku-sho Ltd. at a temperature of 60 °C, a shear strain of 10%, an amplitude of ±0.5%, and a frequency of 20 Hz.

The undertread 152 is made of a rubber material excellent in heat resistance, is disposed by being sandwiched between the cap tread 151 and the belt layer 14, and constitutes a base portion of the tread rubber 15. The undertread 152 has a rubber hardness Hs_ut of 47 or more and 80 or less, a modulus M_ut (MPa) at 100% elongation of 1.4 or more and 5.5 or less, and a loss tangent tan δ_ut of 0.02 or more and 0.23 or less and preferably the rubber hardness Hs_ut of 50 or more and 65 or less, the modulus M_ut (MPa) at 100% elongation of 1.7 or more and 3.5 or less, and the loss tangent tan δ_ut of 0.03 or more and 0.10 or less.

A difference in the rubber hardness Hs_cap−Hs_ut is in the range of 3 or more and 20 or less and preferably in the range of 5 or more and 15 or less. A difference in modulus M_cap−M_ut (MPa) is in the range of 0 or more and 1.4 or less and preferably in the range of 0.1 or more and 1.0 or less. A difference in loss tangent tan δ_cap−tan δ_ut is in the range of 0 or more and 0.22 or less and preferably in the range of 0.02 or more and 0.16 or less.

The pair of sidewall rubbers 16, 16 is respectively disposed on an outer side of the carcass layer 13 in the tire width direction to constitute left and right sidewall portions. In the configuration of FIG. 1, an end portion of the sidewall rubber 16 on the outer side in the tire radial direction is disposed in a lower layer of the tread rubber 15 and is sandwiched between an end portion of the belt layer 14 and the carcass layer 13. However, no such limitation is intended, and the end portion of the sidewall rubber 16 on the outer side in the tire radial direction may be disposed in an outer layer of the tread rubber 15 and exposed in a buttress portion of the tire (not illustrated). In this case, a belt cushion (not illustrated) is sandwiched between the end portion of the belt layer 14 and the carcass layer 13.

The sidewall rubber 16 has a rubber hardness Hs sw of 48 or more and 65 or less, a modulus M_sw (MPa) at 100% elongation of 1.0 or more and 2.4 or less, and a loss tangent tan δ_sw of 0.02 or more and 0.22 or less and preferably the rubber hardness Hs_sw of 50 or more and 59 or less, the modulus M_sw (MPa) at 100% elongation of 1.2 or more and 2.2 or less, and the loss tangent tand_sw of 0.04 or more and 0.20 or less.

The pair of rim cushion rubbers 17, 17 extends from an inner side in the tire radial direction of the left and right bead cores 11, 11 and turned back portions of the carcass layer 13 toward the outer side in the tire width direction, and constitutes rim fitting surfaces of the bead portions. In the configuration of FIG. 1, an end portion of the rim cushion rubber 17 on the outer side in the tire radial direction is inserted to a lower layer of the sidewall rubber 16 and is disposed by being sandwiched between the sidewall rubber 16 and the carcass layer 13. The rim cushion rubber 17 has a rubber hardness Hs_rc of 60 or more and 80 or less, a modulus M_rc (MPa) at 100% elongation of 2.0 or more and 7.0 or less, and a loss tangent tan δ_rc of 0.09 or more and 0.35 or less and preferably the rubber hardness Hs_rc of 65 or more and 75 or less, the modulus M_rc (MPa) at 100% elongation of 3.0 or more and 6.0 or less, and the loss tangent tan δ_rc of 0.11 or more and 0.30 or less.

The innerliner 18 is an air penetration preventing layer disposed on a tire inner surface and covering the carcass layer 13, suppresses oxidation caused by exposure of the carcass layer 13, and prevents leaking of the air inflated in the tire. The innerliner 18 may be made of, for example, a rubber composition containing butyl rubber as a main component, or may be made of a thermoplastic resin, a thermoplastic elastomer composition containing an elastomer component blended with a thermoplastic resin, or the like.

In FIG. 1, a tire outer diameter OD (mm) is in the range 200≤OD≤660 and preferably in the range 250≤OD≤580. By applying such a tire having the small diameter as a target, an effect of improving load performance described later is significantly obtained. A total tire width SW (mm) is in the range 100≤SW≤400 and preferably in the range 105≤SW≤340. In the tire 1 having the small diameter, for example, a floor of a small vehicle can be lowered to expand a vehicle interior space. Further, since rotational inertia is small and a tire weight is also small, fuel economy is improved and transportation cost is reduced. In particular, when the tire is mounted on an in-wheel motor of a vehicle, a load on a motor is effectively reduced.

The tire outer diameter OD is measured when the tire is mounted on a specified rim, inflated to a specified internal pressure, and in an unloaded state.

The total tire width SW is measured as a linear distance between sidewalls (including all portions such as letters and patterns on the tire side surface) when the tire is mounted on a specified rim, inflated to a specified internal pressure, and in an unloaded state.

A specified rim refers to an “Applicable Rim” defined by the Japan Automobile Tyre Manufacturers Association, Inc. (JATMA), a “Design Rim” defined by the Tire and Rim Association, Inc. (TRA), or a “Measuring Rim” defined by the European Tyre and Rim Technical Organisation (ETRTO). Additionally, “specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in the case of JATMA, for a tire for a passenger vehicle, the specified internal pressure is an air pressure of 180 kPa, and the specified load is 88% of the maximum load capacity.

The total tire width SW (mm) with respect to the tire outer diameter OD (mm) is in the range 0.23≤SW/OD≤0.84 and preferably in the range 0.25≤SW/OD≤0.81.

The tire outer diameter OD and the total tire width SW preferably satisfy the following mathematical formula (1). Here, A1min=−0.0017, A2min=0.9, A3min=130, A1max =−0.0019, A2max=1.4, and A3max=400 and preferably A1min=−0.0018, A2min=0.9, A3min=160, A1max=−0.0024, A2max=1.6, and A3max=362.

A1min*SW\hat{ }2+A2min*SW+A3min≤OD≤A1max*SW\hat{ }2+A2max*SW+A3max (1)

In the tire 1, the use of the rim 10 having a rim diameter of 5 inches or more and 16 inches or less (in other words, 125 mm or more and 407 mm or less) is assumed. A rim diameter RD (mm) with respect to the tire outer diameter OD (mm) is in the range 0.50≤RD/OD≤0.74 and preferably in the range 0.52≤RD/OD≤0.71. The lower limit can ensure the rim diameter RD and in particular, ensure an installation space for an in-wheel motor. The upper limit ensures an internal volume V of the tire described later and ensures the load capacity of the tire.

Note that the tire inner diameter is equal to the rim diameter RD of the rim 10.

The use of the tire 1 at an internal pressure higher than a specified internal pressure, specifically, an internal pressure of 350 kPa or more and 1200 kPa or less and preferably 500 kPa or more and 1000 kPa or less is assumed. The lower limit effectively reduces the rolling resistance of the tire, and the upper limit ensures safety of internal pressure inflation work.

The tire 1 is assumed to be mounted on a vehicle traveling at a low speed, such as a small shuttle bus. The maximum speed of the vehicle is 100 km/h or less, preferably 80 km/h or less, and more preferably 60 km/h or less. The tire 1 is assumed to be mounted on a vehicle having 6 to 12 wheels. This properly exhibits the load capacity of the tire.

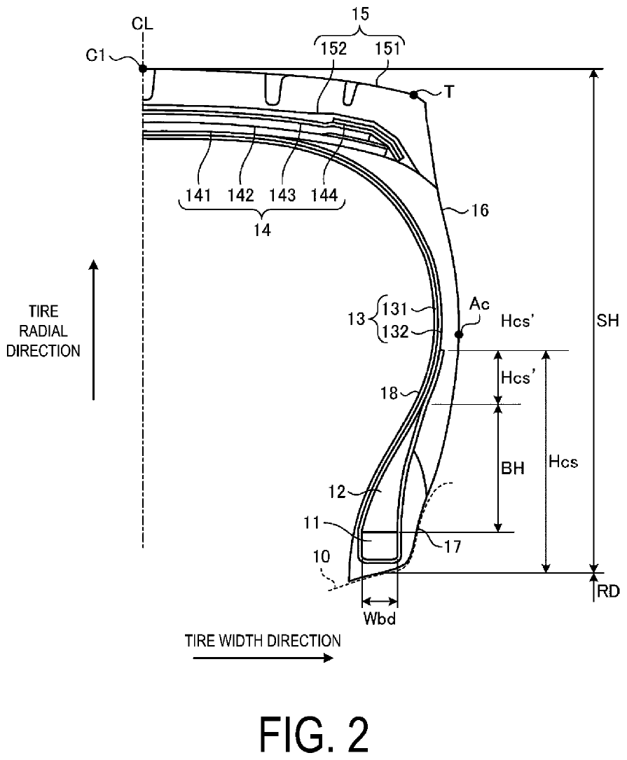

An aspect ratio of the tire, that is, a ratio SH/DW between a tire cross sectional height SH (mm) (see FIG. 2 described below) and a tire cross-sectional width DW (mm), is in the range 0.16≤SH/DW≤0.85 and preferably in the range 0.19≤SH/DW≤0.82.

The tire cross-sectional height SH is half a distance of a difference between a tire outer diameter and a rim diameter, and is measured when the tire is mounted on a specified rim, inflated to a specified internal pressure, and in an unloaded state.

The tire cross-sectional width DW is measured as a linear distance between sidewalls (excluding patterns, letters, and the like on the tire side surface) when the tire is mounted on a specified rim, inflated to a specified internal pressure, and in an unloaded state.

A tire ground contact width TW with respect to the total tire width SW is in the range 0.50≤TW/SW≤0.85 and preferably in the range 0.60≤TW/SW≤0.80.

The tire ground contact width TW is measured as a maximum linear distance in a tire axial direction on a contact surface between the tire and a flat plate when the tire is mounted on a specified rim, inflated to a specified internal pressure, placed perpendicular to the flat plate in a static state, and subjected to a load corresponding to the specified load.

The tire internal volume V (m\hat{ }3) with respect to the tire outer diameter OD (mm) is in the range 4.0≤(V/OD)×10\hat{ }6≤60 and preferably in the range 6.0≤(V/OD)×10\hat{ }6≤50. This properly sets the tire internal volume V. Specifically, the lower limit ensures the tire internal volume and ensures the load capacity of the tire. In particular, since the small-diameter tire is assumed to be used under a high internal pressure and a high load, the tire internal volume V is preferably sufficiently ensured. The upper limit suppresses the increase in size of the tire caused by the excessive tire internal volume V.

The tire internal volume V (m\hat{ }3) with respect to the rim diameter RD (mm) is in the range 0.5≤V×RD≤17 and preferably in the range 1.0≤V×RD≤15.

### Bead Core and Bead Filler

In FIG. 1, as described above, the pair of bead cores 11, 11 are formed by winding up one or a plurality of bead wires (not illustrated) made of steel in an annular shape and multiple times. The pair of bead fillers 12, 12 is disposed on an outer circumference of the pair of bead cores 11, 11 in the tire radial direction, respectively.

A tensile strength Tbd (N) of one bead core 11 with respect to the tire outer diameter OD (mm) is in the range 45≤Tbd/OD≤120, preferably in the range 50≤Tbd/OD≤110, and more preferably in the range 60≤Tbd/OD≤105. The tensile strength Tbd (N) of the bead core with respect to the total tire width SW (mm) is in the range 90≤Tbd/SW≤400 and preferably in the range 110≤Tbd/SW≤350. This properly ensures the load capacity of the bead core 11. Specifically, the lower limit suppresses tire deformation during use under a high load and ensures the durability performance of the tire. The use under a high internal pressure is possible, and the rolling resistance of the tire is reduced. In particular, since the small-diameter tire is assumed to be used under a high internal pressure and a high load, the durability performance and the reduction effect of the rolling resistance of the tire described above are significantly obtained. The upper limit suppresses the deterioration of the rolling resistance caused by the increase in the weight of the bead core.

The tensile strength Tbd (N) of the bead core 11 is calculated as a product of the tensile strength (N/wire) per bead wire and the total number (wires) of bead wires in a radial cross-sectional view. The tensile strength of the bead wire is measured by a tensile test at a temperature of 20 °C in accordance with JIS K1017.

The tensile strength Tbd (N) of the bead core 11 with respect to the tire outer diameter OD (mm), a distance SWD (mm), and the rim diameter RD (mm) preferably satisfies the following mathematical formula (2). Here, B1min=0.26, B2min=10.0, B1max=2.5, and B2max=99.0, preferably B1min=0.35, B2min=14.0, B1max=2.5, and B2max=99.0, more preferably B1min=0.44, B2min=17.6, B1max=2.5, and B2max=99.0, and even more preferably B1min=0.49, B2min=17.9, B1max=2.5, and B2max=99.0. Further, B1min=0.0016×P and B2min=0.07×P are preferable with the use of a specified internal pressure P (kPa) of the tire.

B1min*{(OD/2)\hat{ }2−(SWD/2)\hat{ }2}+B2min*RD≤Tbd≤B1max*{(OD/2)\hat{ }2−(SWD/2)\hat{ }2}+B2max*RD (2)

The distance SWD is a distance twice a radial distance from the tire rotation axis (not illustrated) to a tire maximum width position Ac, that is, a diameter of the tire maximum width position Ac, and is measured when the tire is mounted on a specified rim, inflated to a specified internal pressure, and in an unloaded state.

The tire maximum width position Ac is defined as the maximum width position of the tire cross-sectional width DW defined by JATMA.

In a radial cross-sectional view of one bead core 11, a total cross-sectional area σbd (mm\hat{ }2) of the bead wire made of the steel described above with respect to the tire outer diameter OD (mm) is in the range 0.025≤σbd/OD≤0.075 and preferably in the range 0.030≤σbd/OD≤0.065. The total cross-sectional area σbd (mm\hat{ }2) of the bead wire is in the range 11≤σbd≤36 and preferably in the range 13≤σbd≤33. This achieves the above-described tensile strength Tbd (N) of the bead core 11.

The total cross-sectional area σbd (mm\hat{ }2) of the bead wire is calculated as a sum of the cross-sectional areas of the bead wires in the radial cross-sectional view of one bead core 11.

For example, in the configuration of FIG. 1, the bead core 11 has a quadrangular shape formed by arraying the bead wires (not illustrated) having a circular cross-section in a lattice shape. However, no such limitation is intended, and the bead core 11 may have a hexagonal shape formed by arraying the bead wires having a circular cross-section in a closest-packed structure (not illustrated). Besides, any arrangement structure of bead wires can be employed within the scope apparent to one skilled in the art.

The total cross-sectional area σbd (mm\hat{ }2) of the bead wire preferably satisfies the following mathematical formula (3) with respect to the tire outer diameter OD (mm), the distance SWD (mm), and the rim diameter RD (mm).

Here, Cmin=30 and Cmax=8 and preferably Cmin=25 and Cmax=10.

(OD*RD)/(Cmin*SWD)≤σbd≤(OD*RD)/(Cmax*SWD) (3)

The total cross-sectional area σbd (mm\hat{ }2) of the bead wire with respect to the total number of cross-sections (in other words, the total number of windings) Nbd (wires) of the bead wires of one bead core 11 in the radial cross-sectional view is in the range 0.50≤σbd/Nbd≤1.40 and preferably in the range 0.60≤σbd/Nbd≤1.20. In other words, a cross-sectional area σbd′ (mm\hat{ }2) of a single bead wire is in the range 0.50 mm\hat{ }×2/piece or more and 1.40 mm\hat{ }2/piece or less and preferably in the range 0.60 mm\hat{ }2/piece or more and 1.20 mm\hat{ }2/piece or less.

A maximum width Wbd (mm) (see FIG. 2 described later) of one bead core 11 in the radial cross-sectional view with respect to the total cross-sectional area σbd (mm\hat{ }2) of the bead wire is in the range 0.16≤Wbd/σbd≤0.50 and preferably in the range 0.20≤Wbd/σbd≤0.40.

In FIG. 1, a distance Dbd (mm) between the centers of gravity of the pair of bead cores 11, 11 with respect to the total tire width SW (mm) is in the range 0.63≤Dbd/SW≤0.97 and preferably in the range 0.65≤Dbd/SW≤0.95. The lower limit reduces an amount of deflection of the tire and reduces the rolling resistance of the tire. The upper limit reduces stress acting on the tire side portion and suppresses a tire failure.

In FIG. 2, a radial distance BH (mm) from an end portion on the outer side of the bead core 11 in the radial direction to an end portion on the outer side of the bead filler 12 in the radial direction, that is, the height of the bead filler 12, with respect to the tire cross-sectional height SH (mm) is in the range 0.10≤BH/SH≤0.40 and preferably in the range 0.15≤BH/SH≤0.35.

The radial distance BH (mm) is measured when the tire is mounted on a specified rim, inflated to a specified internal pressure, and in an unloaded state. Carcass Layer

FIG. 2 is an enlarged view illustrating the tire 1 illustrated in FIG. 1.

The same drawing illustrates the half region demarcated by the tire equatorial plane CL.

In the configuration of FIG. 1, as described above, the carcass layer 13 has a single-layered carcass ply and is disposed to extend in the toroidal shape between the left and right bead cores 11, 11. Both end portions of the carcass layer 13 are turned back toward outer sides in the tire width direction and fixed to wrap the bead cores 11 and the bead fillers 12.

A tensile strength Tcs (N/50 mm) per a width of 50 mm of the carcass ply constituting the carcass layer 13 with respect to the tire outer diameter OD (mm) is in the range 17≤Tcs/OD≤120 and preferably in the range 20≤Tcs/OD≤120. The tensile strength Tcs (N/50 mm) of the carcass layer 13 with respect to the total tire width SW (mm) is in the range 30≤Tcs/SW≤260 and preferably in the range 35≤Tcs/SW≤220. Such a configuration appropriately ensures the load capacity of the carcass layer 13 in the small-diameter tire and has an advantage of providing the durability performance and the low rolling resistance performance of the tire in a compatible manner. Specifically, the lower limit suppresses tire deformation during use under a high load and ensures the durability performance of the tire. The use under a high internal pressure is possible, and the rolling resistance of the tire is reduced. In particular, since the small-diameter tire is assumed to be used under a high internal pressure and a high load, the durability performance and the reduction effect of the rolling resistance of the tire described above are significantly obtained. The upper limit suppresses the deterioration of the rolling resistance caused by the increase in the weight of the carcass layer.

The tensile strength Tcs (N/50 mm) of the carcass ply is calculated as follows. In other words, the carcass ply extending between the left and right bead cores 11, 11 and extending over the entire region of the tire inner circumference is defined as an effective carcass ply. The product of the tensile strength (N/cord) per carcass cord constituting the effective carcass ply and the number of insertions (cord/ 50 mm) of the carcass cords per width of 50 mm on the tire equatorial plane CL over the entire circumference of the tire is calculated as the tensile strength Tcs (N/50 mm) of the carcass ply. The tensile strength of the carcass cord is measured by a tensile test at a temperature of 20 °C in accordance with JIS K1017. For example, in a configuration in which one carcass cord is formed by intertwining, for example, a plurality of yarns, the tensile strength of the intertwined one carcass cord is measured, and the tensile strength Tcs of the carcass layer 13 is calculated. In a configuration in which the carcass layer 13 has a multilayer structure (not illustrated) formed by layering a plurality of the effective carcass plies, the above-described tensile strength Tes is defined for each of the plurality of effective carcass plies.

For example, in the configuration of FIG. 1, the carcass layer 13 has a single layer structure formed of a single carcass ply (reference sign omitted in drawings), and the carcass ply is configured by arraying carcass cords made of steel covered with a coating rubber at a cord angle of 80 degrees or more and 100 degrees or less with respect to the tire circumferential direction (not illustrated). The carcass cord made of the steel described above has a cord diameter φcs (mm) in the range 0.15≤φcs≤1.10 and preferably in the range 0.25≤φcs≤0.60 and the number of insertions Ecs (cord/ 50 mm) in the range 25≤Ecs≤80 and preferably in the range 50≤Ecs≤80, and thus the above-described tensile strength Tcs (N/50 mm) of the carcass layer 13 is achieved. The carcass cord is formed by intertwining a plurality of the yarns, and a yarn diameter φcss (mm) thereof is in the range 0.12≤φcss≤0.24 and preferably in the range 0.14≤φcss≤0.22. The yarn diameter css (mm) of the carcass cord with respect to the cord diameter φcs (mm) of the carcass cord is more preferably in the range 0.30≤φcss/φcs≤0.90. Note that the carcass cords may be formed of inorganic fiber (for example, carbon fiber, glass fiber, or the like) other than steel.

No such limitation is intended, and the carcass ply may be constituted by a carcass cord made of an organic fiber material (for example, aramid, nylon, polyester, rayon, or the like) covered with a coating rubber. In this case, the carcass cord made of the organic fiber material has the cord diameter φcs (mm) in the range 0.60≤φcs≤0.90 and the number of insertions Ecs (cord/50 mm) in the range 40≤Ecs≤70, and thus the above-described tensile strength Tcs (N/50 mm) of the carcass layer 13 is achieved. Besides, the carcass cord made of the high-tensile strength organic fiber material, such as nylon, aramid, and hybrid, can be employed within the scope of obviousness by one skilled in the art.

The carcass layer 13 may have a multilayer structure formed by layering a plurality of carcass plies, for example, two layers (not illustrated). This can effectively enhance the load capacity of the tire.

A total tensile strength TTcs (N) of the carcass layer 13 with respect to the tire outer diameter OD (mm) is in the range 300≤TTcs/OD≤3500 and preferably in the range 400≤TTcs/OD≤3000. This ensures the load capacity of the entire carcass layer 13.

The total tensile strength TTcs (N) of the carcass layer 13 is calculated as a product of the tensile strength (N/cord) per carcass cord and the total number of insertions (pieces) of the carcass cords in the entire carcass layer 13. Therefore, the total tensile strength TTcs (N) of the carcass layer 13 increases with an increase in the tensile strength Tcs (N/50 mm) of each carcass ply, the number of layered carcass plies, a circumferential length of the carcass ply, and the like.

The total tensile strength TTcs (N) of the carcass layer 13 with respect to the tire outer diameter OD (mm) and the distance SWD (mm) preferably satisfies the following mathematical formula (4). Here, Dmin=2.2 and Dmax=40, preferably Dmin=4.3 and Dmax=40, more preferably Dmin=6.5 and Dmax=40, and even more preferably Dmin=8.7 and Dmax=40. Further, Dmin=0.02×P is preferable with the use of a specified internal pressure P (kPa) of the tire.

Dmin*{(OD/2)\hat{ }2−(SWD/2)\hat{ }2}≤TTcs≤Dmax*{(OD/2)\hat{ }2−(SWD/2)\hat{ }2} (4)

In the configuration of FIG. 1, the carcass layer 13 includes a body portion 131 extending along the tire inner surface and a turned-up portion 132 turned up to the outer side in the tire width direction so as to wrap around the bead cores 11 and extending in the tire radial direction. In FIG. 2, a radial height Hcs (mm) from a measurement point of the rim diameter RD to an end portion of the turned-up portion 132 of the carcass layer 13 with respect to the tire cross-sectional height SH (mm) is in the range 0.10≤Hcs/SH≤0.49 and preferably in the range 0.15≤Hcs/SH≤0.47. Thus, the radial height Hcs of the turned-up portion 132 of the carcass layer 13 is properly set. Specifically, the lower limit ensures the load capacity of the tire side portion, and the upper limit suppresses the deterioration of the rolling resistance caused by the increase in the weight of the carcass layer.

The radial height Hcs (mm) of the turned-up portion 132 of the carcass layer 13 is measured when the tire is mounted on a specified rim, inflated to a specified internal pressure, and in an unloaded state.

For example, in the configuration of FIG. 2, the end portion (reference sign omitted in drawings) on the outer side of the turned-up portion 132 of the carcass layer 13 in the radial direction is in a region on the inner side in the tire radial direction from the tire maximum width position Ac, and more specifically, in a region from the tire maximum width position Ac to a radial position Al′ of 70% of a distance Hl described below. At this time, a contact height Hcs′ (mm) between the body portion 131 and the turned-up portion 132 of the carcass layer 13 with respect to the tire cross-sectional height SH (mm) is in the range 0.07≤Hcs′/SH and preferably in the range 0.10≤Hcs′/SH. This effectively enhances the load capacity of the tire side portion. The upper limit of the ratio Hcs′/SH is not particularly limited, but is restricted by the contact height Hcs′ having the relationship Hcs′<Hcs with respect to the radial height Hcs of the turned-up portion 132 of the carcass layer 13.

The contact height Hcs′ of the carcass layer 13 is an extension length in the tire radial direction of a region in which the body portion 131 and the turned-up portion 132 are in contact with one another and is measured when the tire is mounted on a specified rim, inflated to a specified internal pressure, and in an unloaded state.

No such limitation is intended, and the carcass layer 13 has a so-called high turn-up structure, and thus the end portion of the turned-up portion 132 of the carcass layer 13 may be disposed in a region on the outer side in the tire radial direction from the tire maximum width position Ac (not illustrated).

### Belt Layer

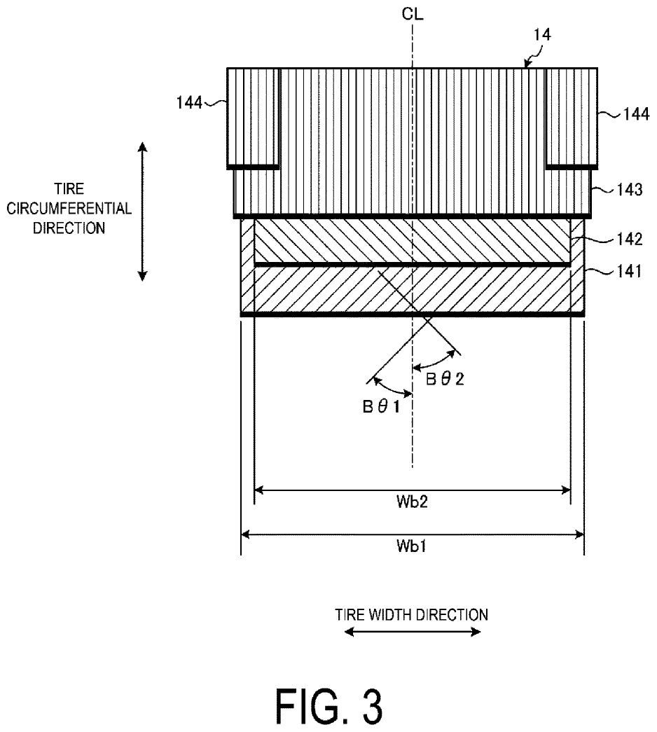

FIG. 3 is an explanatory diagram illustrating the multilayer structure of the belt layer of the tire 1 illustrated in FIG. 1. In the same drawing, the thin lines given to the respective belt plies 141 to 144 schematically illustrate the arrangement configuration of the belt cords.

In the configuration of FIG. 1, as described above, the belt layer 14 is formed by layering the plurality of belt plies 141 to 144. As illustrated in FIG. 3, the belt plies 141 to 144 are constituted by the pair of cross belts 141, 142, the belt cover 143, and the pair of belt edge covers 144, 144.

At this time, the tensile strength Tbt (N/50 mm) per width of 50 mm of each of the pair of cross belts 141, 142 with respect to the tire outer diameter OD (mm) is in the range 25≤Tbt/OD≤250 and preferably in the range 30≤Tbt/OD≤230. The tensile strength Tbt (N/50 mm) of the cross belts 141, 142 with respect to the total tire width SW (mm) is in the range 45≤Tbt/SW≤500 and preferably in the range 50≤Tbt/SW≤450. This properly ensures the respective load capacities of the pair of cross belts 141, 142. Specifically, the lower limit suppresses tire deformation during use under a high load and ensures the durability performance of the tire. The use under a high internal pressure is possible, and the rolling resistance of the tire is reduced. In particular, since the small-diameter tire is assumed to be used under a high internal pressure and a high load, the durability performance and the reduction effect of the rolling resistance of the tire described above are significantly obtained. The upper limit suppresses the deterioration of the rolling resistance caused by the increase in the weight of the cross belt.

The tensile strength Tbt (N/50 mm) of the belt ply is calculated as follows. In other words, a belt ply extending over the entire region of 80% of the tire ground contact width TW centered on the tire equatorial plane CL (in other words, the central portion of the tire ground contact region) is defined as an effective belt ply. The product of the tensile strength (N/cord) per belt cord constituting the effective belt ply and the number of insertions (pieces) of the belt cords per width of 50 mm in the region of 80% of the tire ground contact width TW described above is calculated as the tensile strength Tbt (N/50 mm) of the belt ply. The tensile strength of the belt cord is measured by a tensile test at a temperature of 20 °C in accordance with JIS K1017. For example, in a configuration in which one belt cord is formed by intertwining, for example, a plurality of yarns, the tensile strength of the intertwined one belt cord is measured, and the tensile strength Tbt of the belt ply is calculated. In a configuration in which the belt layer 14 is formed by layering a plurality of the effective belt plies (see FIG. 1), the above-described tensile strength Tbt is defined for each of the plurality of effective belt plies. For example, in the configuration of FIG. 1, the pair of cross belts 141, 142 and the belt cover 143 correspond to the effective belt plies.

For example, in the configuration of FIG. 3, the pair of cross belts 141, 142 is configured by arraying belt cords made of steel covered with a coating rubber at a cord angle (dimension symbol omitted in the drawings) of 15 degrees or more and 55 degrees or less with respect to the tire circumferential direction. The belt cord made of steel has a cord diameter φbt (mm) in the range 0.50≤φbt≤1.80 and the number of insertions Ebt (cord/ 50 mm) in the range 15≤Ebt≤75, and thus the tensile strength Tbt (N/50 mm) of the cross belts 141, 142 is achieved. The cord diameter φbt (mm) and the number of insertions Ebt (cord/ 50 mm) are preferably in the range 0.55≤φbt≤1.60 and 17≤Ebt≤50 and more preferably in the range 0.60≤φbt≤1.30 and 20≤Ebt≤40. The belt cord is formed by intertwining a plurality of the yarns, and a yarn diameter φbts (mm) thereof is in the range 0.16≤φbts≤0.43 and preferably in the range 0.21≤φbts≤0.39.

No such limitation is intended, and the cross belts 141, 142 may be constituted by belt cords made of an organic fiber material (for example, aramid, nylon, polyester, rayon, or the like) covered with a coating rubber. In this case, the belt cord made of the organic fiber material has the cord diameter φbt (mm) in the range 0.50≤φbt≤0.90 and the number of insertions Ebt (cord/50 mm) in the range 30≤Ebt≤65, and thus the above-described tensile strength Tbt (N/50 mm) of the cross belts 141, 142 is achieved. The belt cords made of the high-tensile strength organic fiber material, such as nylon, aramid, and hybrid, can be employed within the scope apparent to one skilled in the art.

The belt layer 14 may include a supplemental belt (not illustrated). The supplemental belt may be, for example, (1) a third cross belt constituted by covering a plurality of belt cords made of steel or an organic fiber material with a coating rubber and performing a rolling process and having a cord angle of 15 degrees or more and 55 degrees or less as an absolute value, or (2) a so-called large-angle belt constituted by covering a plurality of belt cords made of steel or an organic fiber material with a coating rubber and performing a rolling process and having a cord angle of 45 degrees or more and 70 degrees or less as and preferably 54 degrees or more and 68 degrees or less as an absolute value. The supplemental belt may be disposed (a) between the pair of cross belts 141, 142 and the carcass layer 13, (b) between the pair of cross belts 141, 142, or (c) on the outer side of the pair of cross belts 141, 142 in the radial direction (not illustrated). This improves the load capacity of the belt layer 14.

Further, a total tensile strength TTbt (N) of the belt layer 14 with respect to the tire outer diameter OD (mm) is in the range 70≤TTbt/OD≤750, preferably in the range 90≤TTbt/OD≤690, more preferably in the range 110≤TTbt/OD≤690, and further preferably in the range 120≤TTbt/OD≤690. This ensures the load capacity of the entire belt layer 14. Further, 0.16×P≤TTbt/OD is preferable with the use of a specified internal pressure P (kPa) of the tire.

The total tensile strength TTbt (N) of the belt layer 14 is calculated as a product of the tensile strength (N/cord) per belt cord and the total number of insertions (pieces) of the belt cords in the entire belt layer 14. Therefore, the total tensile strength TTbt (N) of the belt layer 14 increases with an increase in the tensile strength Tbt (N/50 mm) of each belt ply, the number of layered belt plies, and the like.

Of the pair of cross belts 141, 142 (in the configuration including the supplemental belt described above, the supplemental belt is included (not illustrated)), a width Wb1 (mm) of the widest cross belt (the radially inner cross belt 141 in FIG. 3) with respect to a width Wb2 (mm) of the narrowest cross belt (the cross belt 142 on the radially outer side in FIG. 3) is in the range 1.00≤Wb1/Wb2≤1.40 and preferably in the range 1.10≤Wb1/Wb2≤1.35. The width Wb2 (mm) of the narrowest cross belt with respect to the total tire width SW (mm) is in the range 0.61≤Wb2/SW≤0.96 and preferably in the range 0.70≤Wb2/SW≤0.94. The lower limit ensures the width of the belt ply, properly sets a ground contact pressure distribution of the tire ground contact region, and ensures uneven wear resistance of the tire. The upper limit reduces strain of the end portion of the belt ply during rolling of the tire and suppresses separation of a peripheral rubber of the belt ply end portion.

The width of a belt ply is the distance in the direction of the tire rotation axis between the left and right end portions of each belt ply, measured when the tire is mounted on a specified rim, inflated to a specified internal pressure, and in an unloaded state.

Of the pair of cross belts 141, 142 (in the configuration including the supplemental belt described above, the supplemental belt is included (not illustrated)), the width Wb1 (mm) of the widest cross belt (the radially inner cross belt 141 in FIG. 3) with respect to the tire ground contact width TW (mm) is in the range 0.85≤Wb1/TW≤1.23 and preferably in the range 0.90≤Wb1/TW≤1.20.

For example, in the configurations of FIGS. 1 to 3, the wide cross belt 141 is disposed in the innermost layer in the tire radial direction, and the narrow cross belt 142 is disposed on the outer side of the wide cross belt 141 in the radial direction. The belt cover 143 is disposed on the outer side of the narrow cross belt 142 in the radial direction to entirely cover both of the pair of cross belts 141, 142. The pair of belt edge covers 144, 144 is disposed on the outer side of the belt cover 143 in the radial direction while being spaced apart from one another to cover respective left and right edge portions of the pair of cross belts 141, 142.

### Tread Profile and Tread Gauge

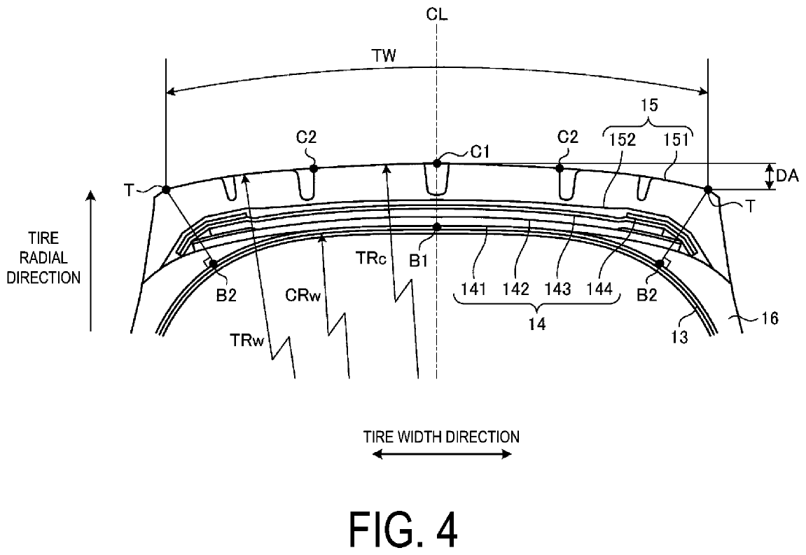

FIG. 4 is an enlarged view illustrating the tread portion of the tire 1 illustrated in FIG. 1.

In FIG. 4, an amount of depression DA (mm) of the tread profile at a tire ground contact edge T, the tire ground contact width TW (mm), and the tire outer diameter OD (mm) have the relationship 0.015≤TW/(DA×OD)≤0.300 and preferably have the relationship 0.020≤TW/(DA×OD)≤0.250. The amount of depression DA (mm) of the tread profile at the tire ground contact edge T with respect to the tire ground contact width TW (mm) has the relationship 0.01≤DA/TW≤0.10 and preferably has the relationship 0.02≤DA/TW≤0.08. As a result, a depression angle (defined by the ratio DA/(TW/2)) of the tread portion shoulder region is properly set and the load capacity of the tread portion is appropriately ensured. Specifically, the lower limit ensures the depression angle of the tread portion shoulder region and suppresses a decrease in wear life caused by an excessive ground contact pressure of the tread portion shoulder region. The upper limit flattens the tire ground contact region, makes the ground contact pressure uniform, and ensures the wear resistance performance of the tire. In particular, since the small diameter tire is assumed to be used under a high internal pressure and a high load, the ground contact pressure distribution in the tire ground contact region can be effectively optimized by the configuration.

The amount of depression DA is the distance in the tire radial direction from the intersection point C1 between the tire equatorial plane CL and the tread profile in the cross-sectional view in the tire meridian direction to the tire ground contact edge T, and is measured when the tire is mounted on a specified rim, inflated to a specified internal pressure, and in an unloaded state.

The tire profile is a contour line of the tire in the cross-sectional view in the tire meridian direction, and is measured using a laser profiler. The laser profiler used may be, for example, a tire profile measuring device (available from Matsuo Co., Ltd.).

The amount of depression DA (mm) of the tread profile at the tire ground contact edge T with respect to the tire outer diameter OD (mm) and the total tire width SW (mm) preferably satisfies the following mathematical formula (5). Here, Emin=2.5 and Emax=17, preferably Emin=3.8 and Emax=13, and more preferably Emin=4.0 and Emax=9.

Emin*(SW/OD)\hat{ }(1/4)≤DA≤Emax*(SW/OD)\hat{ }(1/4) (5)

FIG. 4 defines the point C1 on the tread profile on the tire equatorial plane CL and a pair of points C2, C2 on the tread profile at a distance of ¼ of the tire ground contact width TW from the tire equatorial plane CL.

At this time, a radius of curvature TRc (mm) of an arc passing through the point C1 and the pair of points C2 with respect to the tire outer diameter OD (mm) is in the range 0.15≤TRc/OD≤15 and preferably in the range 0.18≤TRc/OD≤12. The radius of curvature TRc (mm) of the arc is in the range 30≤TRc≤3000, preferably in the range 50≤TRc≤2800, and more preferably in the range 80≤TRc≤2500. This properly ensures the load capacity of the tread portion. Specifically, the lower limit flattens the tread portion center region, makes the ground contact pressure of the tire ground contact region uniform, and ensures the wear resistance performance of the tire. The upper limit suppresses a decrease in wear life caused by an excessive ground contact pressure of the tread portion shoulder region. In particular, since the small diameter tire is assumed to be used under a high internal pressure and a high load, a uniform effect of the ground contact pressure under such a use condition can be effectively obtained.

The radius of curvature of the arc is measured when the tire is mounted on a specified rim, inflated to a specified internal pressure, and in an unloaded state.

In FIG. 4, a radius of curvature TRw (mm) of an arc passing through the point Cl of the tire equatorial plane CL and the left and right tire ground contact edges T, T described above with respect to the tire outer diameter OD (mm) is in the range 0.30≤TRw/OD≤16 and preferably in the range 0.35≤TRw/OD≤11. The radius of curvature TRw (mm) of the arc is in the range 150≤TRw≤2800 and preferably in the range 200≤TRw≤2500. This properly ensures the load capacity of the tread portion. Specifically, the lower limit flattens the entire tire ground contact region, makes the ground contact pressure uniform, and ensures the wear resistance performance of the tire. The upper limit suppresses a decrease in wear life caused by an excessive ground contact pressure of the tread portion shoulder region. In particular, since the small diameter tire is assumed to be used under a high internal pressure and a high load, the ground contact pressure distribution in the tire ground contact region can be effectively optimized by the configuration.

The radius of curvature TRc (mm) of a first arc passing through the points C1, C2 described above with respect to the radius of curvature TRw (mm) of a second arc passing through the point C1 and the tire ground contact edge T is in the range 0.50≤TRw/TRc≤1.00, preferably in the range 0.60≤TRw/TRc≤0.98, and more preferably in the range 0.70≤TRw/TRc≤0.96.

This properly sets a contact patch shape of the tire. Specifically, the lower limit disperses the ground contact pressure of the tread portion center region and improves the wear life of the tire. The upper limit suppresses a decrease in wear life caused by an excessive ground contact pressure of the tread portion shoulder region.

In FIG. 4, a point B1 on the carcass layer 13 on the tire equatorial plane CL and feet B2, B2 of perpendicular lines extending from the left and right tire ground contact edges T, T to the carcass layer 13 are defined.

At this time, a radius of curvature CRw of an arc passing through the point B1 and a pair of points B2, B2 with respect to the radius of curvature TRw of the arc passing through the point C1 and the tire ground contact edges T, T described above is in the range 0.35≤CRw/TRw≤1.60, preferably in the range 0.45≤CRw/TRw≤1.50, and more preferably in the range 0.55≤CRw/TRw≤1.40. The radius of curvature CRw (mm) is in the range 100≤CRw≤2500 and preferably in the range 120≤CRw≤2200. This properly sets a contact patch shape of the tire more. Specifically, the lower limit suppresses a decrease in wear life caused by an increase in rubber gauge in the tread portion shoulder region. The upper limit ensures the wear life in the tread portion center region.

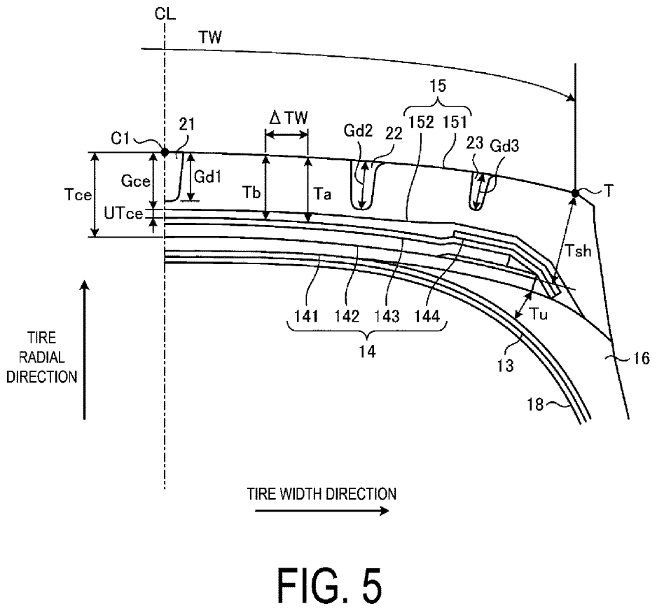

FIG. 5 is an enlarged view illustrating the half region of the tread portion illustrated in FIG. 4.

In the configuration of FIG. 1, as described above, the belt layer 14 includes the pair of cross belts 141, 142 and the tread rubber 15 includes the cap tread 151 and the undertread 152.

In FIG. 5, a distance Tce (mm) from the tread profile on the tire equatorial plane CL to the outer circumferential surface of the wide cross belt 141 with respect to the tire outer diameter OD (mm) has the relationship 0.008≤Tce/OD≤0.13, preferably has the relationship 0.012≤Tce/OD≤0.10, and more preferably has the relationship 0.015≤Tce/OD≤0.07. The distance Tce (mm) is in the range 5≤Tce≤25 and preferably in the range 7≤Tce≤20. This properly ensures the load capacity of the tread portion. Specifically, the lower limit suppresses tire deformation during use under a high load and ensures the wear resistance performance of the tire. In particular, since the small-diameter tire is assumed to be used under a high internal pressure and a high load, the above-described wear resistance performance is significantly obtained. The upper limit suppresses the deterioration of the rolling resistance caused by the increase in the weight of the tread rubber.

The distance Tce is measured when the tire is mounted on a specified rim, inflated to a specified internal pressure, and in an unloaded state.

The outer circumferential surface of the belt ply is defined as a circumferential surface on the outer side in the radial direction of the entire belt ply formed of the belt cords and the coating rubber.

The distance Tce (mm) from the tread profile on the tire equatorial plane CL to the outer circumferential surface of the wide cross belt 141 with respect to the tire outer diameter OD (mm) preferably satisfies the following mathematical formula (6). Here, Fmin=35 and Fmax=207 and preferably Fmin=42 and Fmax=202.

Fmin/(OD)\hat{ }(1/3)≤Tce≤Fmax/(OD)\hat{ }(1/3) (6)

A distance Tsh (mm) from the tread profile at the tire ground contact edge T to the outer circumferential surface of the wide cross belt 141 with respect to the distance Tce (mm) in the tire equatorial plane CL is in the range 0.60≤Tsh/Tce≤1.70, preferably in the range 0.80≤Tsh/Tce≤1.60, and more preferably in the range 1.01≤Tsh/Tce≤1.50. The lower limit ensures the tread gauge in the shoulder region, and therefore repeated deformation of the tire during rolling of the tire is suppressed, and the wear resistance performance of the tire is ensured. The upper limit ensures the tread gauge in the center region, and therefore the tire deformation during use under a high load peculiar to the small-diameter tire is suppressed, and the wear resistance performance of the tire is ensured.

The distance Tsh is measured when the tire is mounted on a specified rim, inflated to a specified internal pressure, and in an unloaded state. When a wide cross belt is not present immediately below the tire ground contact edge T, the distance Tsh is measured as a distance from the tread profile to an imaginary line extended from the outer circumferential surface of the belt ply.

The distance Tsh (mm) from the tread profile to the outer circumferential surface of the wide cross belt 141 at the tire ground contact edge T with respect to the distance Tce (mm) in the tire equatorial plane CL preferably satisfies the following mathematical formula (7). Here, Gmin=0.36 and Gmax=0.72, preferably Gmin=0.37 and Gmax=0.71, and more preferably Gmin=0.38 and Gmax=0.70.

Gmin*(OD)\hat{ }(1/7)≤Tsh/Tce≤Gmax*(OD)\hat{ }(1/7) (7)

In FIG. 5, a section having a width ΔTW of 10% of the tire ground contact width TW is defined. At this time, a ratio between a maximum value Ta and a minimum value Tb of the rubber gauge of the tread rubber 15 in any section in the tire ground contact region is in the range of 0% or more and 40% or less and preferably in the range 0% or more and 20% or less. In such a configuration, since an amount of change in the rubber gauge of the tread rubber 15 in any section in the tire ground contact region (in particular, a section including the end portions of the belt plies 141 to 144) is set to be small, the ground contact pressure distribution in the tire width direction smoothens and the wear resistance performance of the tire is improved.

The rubber gauge of the tread rubber 15 is defined as a distance from the tread profile to the inner circumferential surface of the tread rubber 15 (in FIG. 5, a distance from the outer circumferential surface of the cap tread 151 to the inner circumferential surface of the undertread 152). Therefore, the rubber gauge of the tread rubber 15 is measured with a groove formed in a tread contact surface excluded.

In FIG. 5, a rubber gauge UTce of the undertread 152 at the tire equatorial plane CL with respect to the distance Tce in the tire equatorial plane CL described above is in the range 0.04≤UTce/Tce≤0.60 and preferably in the range 0.06≤UTce/Tce≤0.50. Thus, the rubber gauge UTce of the undertread 152 is properly set.

The above-described distance Tsh in the tire ground contact edge T with respect to a rubber gauge Tu (mm) from the end portion of the wide cross belt 141 to the outer circumferential surface of the carcass layer 13 is in the range 1.50≤Tsh/Tu≤6.90 and preferably in the range 2.00≤Tsh/Tu≤6.50. As a result, the profile of the carcass layer 13 is properly set and tension of the carcass layer 13 is properly set. Specifically, the lower limit ensures the tension of the carcass layer and the tread gauge in the shoulder region, and therefore repeated deformation of the tire during rolling of the tire is suppressed, and the wear resistance performance of the tire is ensured. The upper limit ensures the rubber gauge at or near the end portion of the belt ply, and therefore separation of the peripheral rubber of the belt ply is suppressed.

The rubber gauge Tu is measured as a gauge of rubber members (the sidewall rubber 16 in FIG. 5) inserted between the end portion of the wide cross belt 141 and the carcass layer 13. Specifically, in the cross-sectional view in the tire meridian direction, a perpendicular line drawn from the end portion of the wide cross belt 141 to the outer surface of the carcass layer 13 is constructed, and a total gauge of the rubber members on the perpendicular line is calculated as the rubber gauge Tu.

The outer circumferential surface of the carcass layer 13 is defined as a circumferential surface on the outer side in the radial direction of the entire carcass ply formed of the carcass cords and the coating rubber. When the carcass layer 13 has a multilayer structure formed of a plurality of carcass plies (not illustrated), the outer circumferential surface of the carcass ply of the outermost layer constitutes the outer circumferential surface of the carcass layer 13. When the turned-up portion 132 (see FIG. 1) of the carcass layer 13 is present between the end portion of the wide cross belt 141 and the carcass layer 13 (not illustrated), the outer circumferential surface of the turned-up portion 132 constitutes the outer circumferential surface of the carcass layer 13.

For example, in the configuration of FIG. 5, the sidewall rubber 16 is inserted between the end portion of the wide cross belt 141 and the carcass layer 13 to form the rubber gauge Tu between the end portion of the wide cross belt 141 and the carcass layer 13. However, no such limitation is intended, and, for example, a belt cushion may be inserted between the end portion of the wide cross belt 141 and the carcass layer 13 instead of the sidewall rubber 16 (not illustrated). The inserted rubber member has a rubber hardness Hs_sp of 46 or more and 67 or less, a modulus M_sp (MPa) at 100% elongation of 1.0 or more and 3.5 or less, and a loss tangent tan δ_sp of 0.02 or more and 0.22 or less and preferably has the rubber hardness Hs_sp of 48 or more and 63 or less, the modulus M_sp (MPa) at 100% elongation of 1.2 or more and 3.2 or less, and a loss tangent tan δ_sp of 0.04 or more and 0.20 or less.

In the configuration of FIG. 1, the tire 1 includes, in the tread surface, a plurality of circumferential main grooves 21 to 23 extending in the tire circumferential direction (see FIG. 5) and land portions (reference sign omitted in drawings) defined by the circumferential main grooves 21 to 23. “Main groove” is defined as a groove for which indication of a wear indicator specified by JATMA is mandatory.

At this time, as illustrated in FIG. 5, a groove depth Gd1 (mm) of the circumferential main groove 21 closest to the tire equatorial plane CL among the plurality of circumferential main grooves 21 to 23 with respect to a rubber gauge Gce (mm) of the tread rubber 15 is in the range 0.50≤Gd1/Gce≤1.00 and preferably in the range 0.55≤Gd1/Gce≤0.98. This ensures the wear resistance performance of the tire. Specifically, the lower limit disperses the ground contact pressure of the tread portion center region and improves the wear life of the tire. The upper limit ensures the rigidity of the land portion and ensures the rubber gauge from the groove bottom of the circumferential main groove 21 to the belt layer.

The circumferential main groove closest to the tire equatorial plane CL is defined as the circumferential main groove 21 (see FIG. 5) on the tire equatorial plane CL. When a circumferential main groove is absent on the tire equatorial plane CL (not illustrated), the circumferential main groove is defined as the circumferential main groove closest to the tire equatorial plane CL.

The ratio Gd1/Gce described above with respect to the tire outer diameter OD (mm) preferably satisfies the following mathematical formula (8). Here, Hmin=0.10 and Hmax=0.60, preferably Hmin=0.12 and Hmax=0.50, and more preferably Hmin=0.14 and Hmax=0.40.

Hmin*250/OD≤Gd1/Gce≤Hmax+250/OD (8)

The groove depth Gd1 (mm) of the circumferential main groove 21 closest to the tire equatorial plane CL of the plurality of circumferential main grooves 21 to 23 is deeper than groove depths Gd2 (mm), Gd3 (mm) of the other circumferential main grooves 22, 23 (Gd2≤Gd1, Gd3≤Gd1).

Specifically, when a region from the tire equatorial plane CL to the tire ground contact edge T is bisected in the tire width direction, the groove depth Gd1 of the circumferential main groove (reference sign omitted in drawings) closest to the tire equatorial plane CL with respect to the maximum values of the groove depths Gd2, Gd3 of the other circumferential main grooves (reference sign omitted in drawings) in the region on the tire ground contact edge T side is in the range of 1.00 times or more and 2.50 times or less, preferably in the range of 1.01 times or more and 2.00 times or less, and more preferably in the range of 1.05 times or more and 1.80 times or less. The lower limit disperses the ground contact pressure of the tread portion center region and improves the wear resistance performance of the tire. The upper limit suppresses uneven wear caused by an excessive increase in ground contact pressure difference between the tread portion center region and the shoulder region.

### Side Profile and Side Gauge

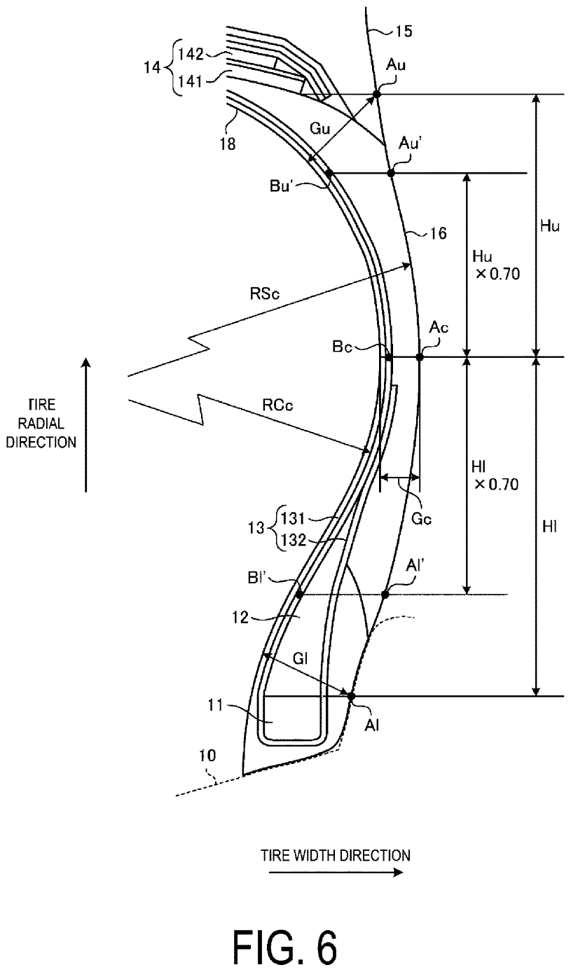

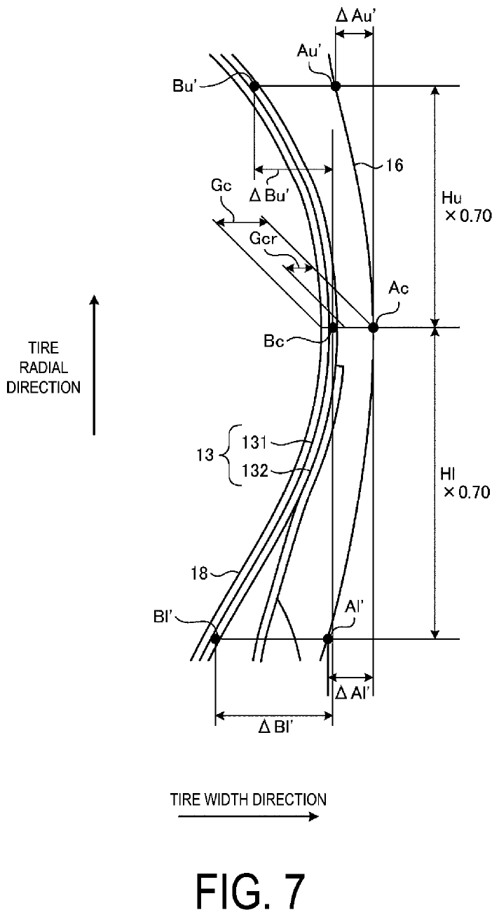

FIG. 6 is an enlarged view illustrating the sidewall portion and the bead portion of the tire 1 illustrated in FIG. 1. FIG. 7 is an enlarged view illustrating the sidewall portion illustrated in FIG. 6.

In FIG. 6, a point Au on the side profile at the same position in the tire radial direction as the end portion of the innermost layer of the belt layer 14 (the radially inner cross belt 141 in FIG. 6) and a point Al on the side profile at the same position in the tire radial direction as the end portion on the outer side in the radial direction of the bead core 11 are defined. A distance Hu from the tire maximum width position Ac to the point Au in the tire radial direction and a distance Hl from the tire maximum width position Ac to the point Al in the tire radial direction are defined. A point Au′ on the side profile at a radial position of 70% of the distance Hu from the tire maximum width position Ac and a point Al′ on the side profile at the radial position of 70% of the distance Hl from the tire maximum width position Ac are defined.

At this time, the sum of the distance Hu (mm) and the distance Hl (mm) with respect to the tire cross-sectional height SH (mm) (see FIG. 2) is in the range 0.45≤(Hu+Hl)/SH≤0.90 and preferably in the range 0.50≤(Hu+Hl)/SH≤0.85. In this way, the radial distance from the belt layer 14 to the bead core 11 is properly set. Specifically, the lower limit ensures a deformable region of the tire side portion and suppresses a failure of the tire side portion (for example, separation of the rubber member at the end portion on the outer side of the bead filler 12 in the radial direction). The upper limit reduces the amount of deflection of the tire side portion during rolling of the tire and reduces the rolling resistance of the tire.

The distance Hu and the distance Hl are measured when the tire is mounted on a specified rim, inflated to a specified internal pressure, and in an unloaded state.

The sum of the distance Hu (mm) and the distance Hl (mm) with respect to tire outer diameter OD (see FIG. 1), the tire cross-sectional height SH (mm) (see FIG. 2), and a radius of curvature RSc (mm) of an arc passing through the tire maximum width position Ac, the point Au′, and the point Al′ preferably satisfies the following mathematical formula (9). Here, I1min=0.06, I1max=0.20, and I2=0.70 and preferably I1min=0.09, I1max=0.20, and I2=0.65.

I1min*(OD/RSc)\hat{ }(1/2)≤(Hu+Hl)/SH≤I2+I1max*(RSc/OD)\hat{ }(1/2) (9)

The radius of curvature RSc of the arc is measured when the tire is mounted on a specified rim, inflated to a specified internal pressure, and in an unloaded state.

The distance Hu (mm) and the distance Hl (mm) have the relationship 0.30≤Hu/(Hu+Hl)≤0.70 and preferably have the relationship 0.35≤Hu/(Hu+Hl)≤0.65. Accordingly, the position of the tire maximum width position Ac in the deformable region of the tire side portion is properly set. Specifically, the lower limit alleviates stress concentration at or near the end portion of the belt ply caused by the tire maximum width position Ac being excessively close to the end portion of the belt layer 14 and suppresses the separation of the peripheral rubber. The upper limit alleviates stress concentration at or near the bead portion caused by the tire maximum width position Ac being excessively close to the end portion of the bead core 11 and suppresses a failure of a reinforcing member (the bead filler 12 in FIG. 6) of the bead portion.

The radius of curvature RSc (mm) of the arc passing through the tire maximum width position Ac, the point Au′, and the point Al′ with respect to the tire outer diameter OD (mm) is in the range 0.05≤RSc/OD≤1.70 and preferably in the range 0.10≤RSc/OD≤1.60. The radius of curvature RSc (mm) of the arc is in the range 25≤RSc≤330 and preferably in the range 30≤RSc≤300. As a result, the radius of curvature of the side profile is properly set and the load capacity of the tire side portion is appropriately ensured. Specifically, the lower limit reduces the amount of deflection of the tire side portion during rolling of the tire and reduces the rolling resistance of the tire. The upper limit alleviates stress concentration caused by the tire side portion becoming flat and improves the durability performance of the tire. In particular, in the small-diameter tire, since large stress tends to act on the tire side portion due to the use under the high internal pressure and the high load described above, there is also a problem that side cut resistance performance of the tire should be ensured. In this regard, the lower limit ensures the radius of curvature of the side profile, suppresses a collapse of the tire by carcass tension being properly set, and suppresses side cut of the tire. The upper limit suppresses the side cut of the tire caused by an excessive tension of the carcass layer 13.

The radius of curvature RSc (mm) of the arc with respect to the tire cross-sectional height SH (mm) is in the range 0.50≤RSc/SH≤0.99 and preferably in the range 0.55≤RSc/SH≤0.97.

The radius of curvature RSc (mm) of the arc with respect to the tire outer diameter OD (mm) and the rim diameter RD (mm) preferably satisfies the following mathematical formula (10). Here, Jmin=15 and Jmax=360, preferably Jmin=20 and Jmax=330, and more preferably Jmin=25 and Jmax=300.

Jmin*(OD/RD)\hat{ }(1/2)≤Rsc≤Jmax+(OD/D)\hat{ }(1/2) (10)

In FIG. 6, a point Bc on the body portion 131 of the carcass layer 13 at the same position as the tire maximum width position Ac in the tire radial direction is defined. A point Bu′ on the body portion 131 of the carcass layer 13 at a radial position of 70% of the above-described distance Hu from the tire maximum width position Ac is defined. A point Bl′ on the body portion 131 of the carcass layer 13 at a radial position of 70% of the above-described distance Hl from the tire maximum width position Ac is defined.

At this time, the radius of curvature RSc (mm) of the arc passing through the tire maximum width position Ac, the point Au′ and the point Al′ described above with respect to a radius of curvature RCc (mm) of an arc passing through the point Bc, the point Bu′, and the point Bl′ is in the range 1.10≤RSc/RCc≤4.00 and preferably in the range 1.50≤RSc/RCc≤3.50. The radius of curvature RCc (mm) of the arc passing through the point Bc, the point Bu′, and the point Bl′ is in the range 5≤RCc≤300 and preferably in the range 10≤RCc≤270. Thus, the relationship between the radius of curvature RSc of the side profile of the tire and the radius of curvature RCc of the side profile of the carcass layer 13 is properly set. Specifically, the lower limit ensures the radius of curvature RCc of the carcass profile, ensures the internal volume V of the tire described below, and ensures the load capacity of the tire. The upper limit ensures total gauges Gu and Gl of the tire side portion described below and ensures the load capacity of the tire side portion.

The radius of curvature RSc (mm) of the side profile described above with respect to the radius of curvature RCc (mm) of the carcass profile and the tire outer diameter OD (mm) preferably satisfies the following mathematical formula (11). Here, Kmin=1 and Kmax=130, preferably Kmin=2 and Kmax=100, and more preferably Kmin=3 and Kmax=70.

Kmin*(OD/RSc)\hat{ }(1/2)≤RCc≤Kmax*(OD/RSc)\hat{ }(1/2) (11)

In FIG. 6, a total gauge Gu (mm) of the tire side portion at the above-described point Au with respect to the tire outer diameter OD (mm) is in the range 0.010≤Gu/OD≤0.080 and preferably in the range 0.015≤Gu/OD≤0.050. Accordingly, the total gauge Gu in the region on the outer side of the tire side portion in the radial direction is properly set. Specifically, the lower limit ensures the total gauge Gu in the region on the outer side of the tire side portion in the radial direction, suppresses the tire deformation during use under a high load, and ensures the durability performance of the tire. In particular, since the small-diameter tire is assumed to be used under a high internal pressure and a high load, the above-described reduction effect of the rolling resistance of the tire is significant obtained. The upper limit suppresses the deterioration of the rolling resistance of the tire caused by the total gauge Gu being excessive.

The total gauge of the tire side portion is measured as a distance from the side profile to the tire inner surface on a perpendicular line drawn from a predetermined point on the side profile to the body portion 131 of the carcass layer 13.

In FIG. 6, the total gauge Gu (mm) at the above-described point Au with respect to a total gauge Gc (mm) of the tire side portion at the tire maximum width position Ac is in the range 1.30≤Gu/Gc≤5.00 and preferably in the range 1.50≤Gu/Gc≤4.00. Accordingly, the gauge distribution of the tire side portion from the tire maximum width position Ac to the innermost layer of the belt layer 14 is properly set. Specifically, the lower limit ensures the total gauge Gu in the region on the outer side in the radial direction, suppresses the tire deformation during use under a high load, and ensures the durability performance of the tire. The upper limit suppresses the deterioration of the rolling resistance of the tire caused by the total gauge Gu being excessive.

The total gauge Gu (mm) at the above-described point Au with respect to the total gauge Gc (mm) at the tire maximum width position Ac and the tire outer diameter OD (mm) preferably satisfies the following mathematical formula (12). Here, Lmin=0.10 and Lmax=0.70, preferably Lmin=0.14 and Lmax=0.70, and more preferably Lmin=0.19 and Lmax=0.70.

Lmin*(OD)\hat{ }(1/3)*Gc≤Gu≤Lmax*(OD)\hat{ }(1/3)*Gc (12)

In FIG. 6, the total gauge Gc (mm) of the tire side portion at the tire maximum width position Ac with respect to the tire outer diameter OD (mm) has the relationship 0.003≤Gc/OD≤0.060 and preferably has the relationship 0.004≤Gc/OD≤0.050. The lower limit ensures the total gauge Gc at the tire maximum width position Ac and ensures the load capacity of the tire. The upper limit ensures the reduction effect of the rolling resistance of the tire by reducing the total gauge Gc at the tire maximum width position Ac.

The total gauge Gc (mm) at the tire maximum width position Ac with respect to the tire outer diameter OD (mm) preferably satisfies the following mathematical formula (13). Here, Mmin=70 and Mmax=450 and preferably Mmin=80 and Mmax=400.

Mmin/(OD)\hat{ }(1/2)≤Gc≤Mmax/(OD)\hat{ }(1/2) (13)

The total gauge Gc (mm) at the tire maximum width position Ac with respect to the tire outer diameter OD (mm) and the total tire width SW (mm) preferably satisfies the following mathematical formula (14). Here, Nmin=0.20 and Nmax=15, preferably Nmin=0.40 and Nmax=15, and more preferably Nmin=0.60 and Nmax=12.

Nmin*(OD/SW)≤Gc≤Nmax*(OD/SW) (14)

The total gauge Gc (mm) at the tire maximum width position Ac with respect to the radius of curvature RSc (mm) of the arc passing through the tire maximum width position Ac, the point Au′, and the point Al′ described above preferably satisfies the following mathematical formula (15). Here, Omin=13 and Omax=260 and preferably Omin=20 and Omax=200.

Omin/(RSc)\hat{ }(1/2)≤Gc≤Omax/(RSc)\hat{ }(1/2) (15)

In FIG. 6, a total gauge Gl (mm) of the tire side portion at the above-described point Al with respect to the tire outer diameter OD is in the range 0.010≤Gl/OD≤0.150 and preferably in the range 0.015≤Gl/OD≤0.100. Accordingly, the total gauge Gl in the region on the inner side of the tire side portion in the radial direction is properly set. Specifically, the lower limit ensures the total gauge Gl in the region on the inner side of the tire side portion in the radial direction, suppresses the tire deformation during use under a high load, and ensures the durability performance of the tire. In particular, since the small-diameter tire is assumed to be used under a high internal pressure and a high load, the above-described reduction effect of the rolling resistance of the tire is significant obtained. The upper limit suppresses the deterioration of the rolling resistance of the tire caused by the total gauge Gl being excessive.

In FIG. 6, a ratio Gl/Gc of the total gauge Gl (mm) of the tire side portion at the point Al to the total gauge Gc (mm) of the tire side portion at the tire maximum width position Ac is in the range 1.00≤Gl/Gc≤7.00 and preferably in the range 1.50≤Gl/Gc≤4.00. Accordingly, the gauge distribution of the tire side portion from the tire maximum width position Ac to the bead core 11 is properly set. Specifically, the lower limit ensures the total gauge Gl in the region on the inner side in the radial direction, suppresses the tire deformation during use under a high load, and ensures the durability performance of the tire. The upper limit suppresses the deterioration of the rolling resistance of the tire caused by the total gauge Gl being excessive.

The total gauge Gl (mm) of the tire side portion at the above-described point Al with respect to the total gauge Gc (mm) at the tire maximum width position Ac and the tire outer diameter OD (mm) preferably satisfies the following mathematical formula (16). Here, Pmin=0.12 and Pmax=1.00, preferably Pmin=0.15 and Pmax=1.00, and more preferably Pmin=0.18 and Pmax=1.00.

Pmin*(OD)\hat{ }(1/3)*Gc≤Gl≤Pmax*(OD)\hat{ }(1/3)*Gc (16)

In FIG. 6, the total gauge Gl (mm) at the above-described point Al with respect to the total gauge Gu (mm) at the above-described point Au is in the range 0.50≤Gl/Gu≤5.00 and preferably in the range 1.00≤Gl/Gu≤3.00. Accordingly, the ratio between the total gauge Gl in the region on the inner side in the radial direction and the total gauge Gu in the region on the outer side in the radial direction of the tire side portion is properly set.

The total gauge Gl (mm) at the above-described point Al with respect to the total gauge Gu (mm) at the above-described point Au and the tire outer diameter OD (mm) preferably satisfies the following mathematical formula (17). Here, Qmin=0.09 and Qmax=0.80, preferably Qmin=0.10 and Qmax=0.70, and more preferably Qmin=0.11 and Qmax=0.50.

Qmin*(OD)\hat{ }(1/3)*Gu≤Gl≤Qmax*(OD)\hat{ }(1/3)*Gu (17)

In FIG. 6, an average rubber hardness Hsc at the measurement position of the total gauge Gc, an average rubber hardness Hsu at the measurement position of the total gauge Gu, and an average rubber hardness Hsl at the measurement point position of the total gauge Gl have the relationship Hsc≤Hsu<Hsl, preferably have the relationship 1≤Hsu−Hsc≤18 and 2≤Hsl−Hsu≤27, and more preferably have the relationship 2≤Hsu−Hsc≤15 and 5≤Hsl−Hsu≤23. Accordingly, the relationship between the rubber hardnesses of the tire side portion is properly set.

The average rubber hardnesses Hsc, Hsu, Hsl are calculated as the sum of values obtained by dividing the product of the cross-sectional lengths and the rubber hardnesses of the respective rubber members at the respective measurement points of the total gauge Gc (mm) at the tire maximum width position Ac, the total gauge Gu at the point Au, and the total gauge Gl at the point Al by the total gauge.

In FIG. 7, a distance ΔAu′ (mm) from the tire maximum width position Ac to the point Au′ in the tire width direction with respect to 70% of the distance Hu (mm) from the tire maximum width position Ac described above is in the range 0.03≤ΔAu′/(Hu×0.70)≤0.25 and preferably in the range 0.07≤ΔAu′/(Hu×0.70)≤0.23. Thus, a degree of curvature of the side profile in the region on the outer side in the radial direction is properly set. Specifically, the lower limit alleviates stress concentration caused by the flat tire side portion becoming flat and improves the durability performance of the tire. The upper limit reduces the amount of deflection of the tire side portion during rolling of the tire and reduces the rolling resistance of the tire. In particular, in the small diameter tire, since large stress tends to act on the tire side portion due to the use under the high internal pressure and the high load described above has also a problem that side cut resistance performance of the tire should be ensured. In this regard, the lower limit ensures the radius of curvature of the side profile, suppresses a collapse of the tire by carcass tension being properly set, and suppresses side cut of the tire. The upper limit suppresses the side cut of the tire caused by an excessive tension of the carcass layer 13.

A distance ΔAl′ (mm) from the tire maximum width position Ac to the point Al′ in the tire width direction with respect to 70% of the distance Hl (mm) from the tire maximum width position Ac is in the range 0.03≤ΔAl′/(Hl×0.70)≤0.28 and preferably in the range 0.07≤ΔAl′/(Hl×0.70)≤0.20. Thus, the degree of curvature of the side profile in the region on the inner side in the radial direction is properly set. Specifically, the lower limit alleviates stress concentration caused by the flat tire side portion becoming flat and improves the durability performance of the tire. In particular, in the small-diameter tire, since the bead core 11 is reinforced as described above, the stress concentration at and near the bead core 11 is effectively suppressed. The upper limit reduces the amount of deflection of the tire side portion during rolling of the tire and reduces the rolling resistance of the tire.

The distances ΔAu′ and ΔAl′ are measured when the tire is mounted on a specified rim, inflated to a specified internal pressure, and in an unloaded state. The distance ΔAu′ (mm) from the tire maximum width position Ac to the point Au′ in the tire width direction with respect to the radius of curvature RSc (mm) of the arc passing through the tire maximum width position Ac, the point Au′, and the point Al′ described above preferably satisfies the following mathematical formula (18). Here, Rmin=0.05 and Rmax=5.00 and preferably Rmin=0.10 and Rmax=4.50.

Rmin*(RSc)\hat{ }(1/2)≤ΔAu′≤Rmax*(RSc)\hat{ }(1/2) (18)

In FIG. 7, a distance ΔBu′ (mm) from the point Bc to the point Bu′ in the tire width direction with respect to the distance ΔAu′ (mm) from the tire maximum width position Ac to the point Au′ in the tire width direction is in the range 1.00≤ΔBu′/ΔAu′≤7.00 and preferably in the range 1.10≤ΔBu′/ΔAu′≤6.00. Thus, the relationship between the degree of curvature of the side profile and the degree of curvature of the carcass profile in the region on the outer side in the radial direction is properly set. Specifically, the lower limit ensures the cut resistance performance of the tire side portion. The upper limit ensures the tension of the carcass layer 13, ensures the rigidity of the tire side portion, and ensures the load capacity and the durability performance of the tire.

In FIG. 7, a distance ΔBl′ (mm) from the point Bc to the point Bl′ in the tire width direction with respect to the distance ΔAl′ (mm) from the tire maximum width position Ac to the point Al′ in the tire width direction is in the range 2.00≤ΔBl′/ΔAl′≤11.0 and preferably in the range 1.90≤ΔBl′/ΔAl′≤9.50. Thus, the relationship between the degree of curvature of the side profile and the degree of curvature of the carcass profile in the region on the inner side in the radial direction is properly set. Specifically, the lower limit ensures the total gauge Gl of the tire side portion and ensures the load capacity of the tire side portion. The upper limit ensures the tension of the carcass layer 13, ensures the rigidity of the tire side portion, and ensures the load capacity and the durability performance of the tire.

The distances ΔBu′, ΔBl′ are measured when the tire is mounted on a specified rim, inflated to a specified internal pressure, and in an unloaded state.

The distance ΔBu′ (mm) from the point Bc to the point Bu′ in the tire width direction with respect to the radius of curvature RCc (mm) of the arc passing through the point Bc, the point Bu′, and the point Bl′ described above preferably satisfies the following mathematical formula (19). Here, Smin=0.40 and Smax=7.0 and preferably Smin=0.50 and Smax=6.0.

Smin*(RSc)\hat{ }(1/2)≤ΔBu′≤Smax*(RSc)\hat{ }(1/2) (19)

In FIG. 7, a rubber gauge Gcr (mm) of the sidewall rubber 16 at the tire maximum width position Ac with respect to the total gauge Gc (mm) at the tire maximum width position Ac described above is in the range 0.35≤Gcr/Gc≤0.90. The rubber gauge Gcr (mm) of the sidewall rubber 16 is in the range 1.5≤Ger and preferably in the range 2.0≤Gcr. The lower limit ensures the rubber gauge Gcr (mm) of the sidewall rubber 16 and ensures the load capacity of the sidewall portion.

The rubber gauge Gcr (mm) of the sidewall rubber 16 at the tire maximum width position Ac with respect to the total gauge Gc (mm) at the tire maximum width position Ac and the tire outer diameter OD (mm) described above preferably satisfies the following mathematical formula (20). Here, Tmin=80 and Tmax=0.90 and preferably Tmin=120 and Tmax=0.90.

Gc*(Tmin/OD)≤Gcr≤Gc*Tmax (20)

In FIG. 7, a rubber gauge Gin (mm) (not illustrated) of the innerliner 18 at the tire maximum width position Ac with respect to the total gauge Gc (mm) at the tire maximum width position Ac is in the range 0.03≤Gin/Gc≤0.50 and preferably in the range 0.05≤Gin/Gc≤0.40. This properly protects the inner surface of the carcass layer 13.

### Carcass Ply and belt Ply

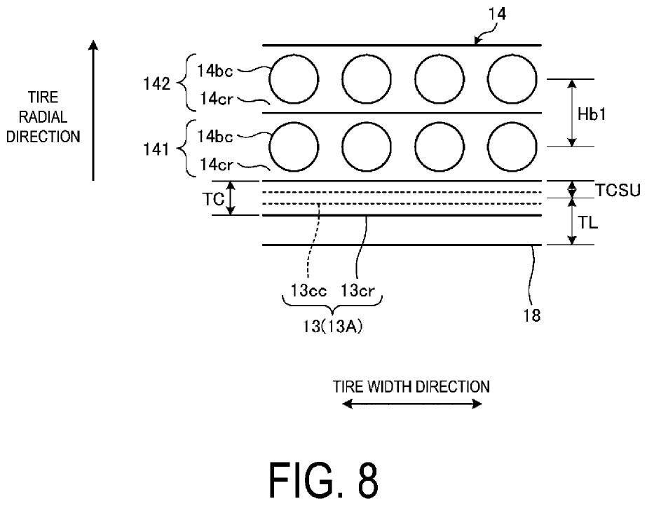

FIG. 8 is an explanatory diagram illustrating the multilayer structure of the carcass layer and the belt layer of the tire illustrated in FIG. 1. The drawing illustrates an enlarged view in the cross-sectional view in the tire meridian direction.

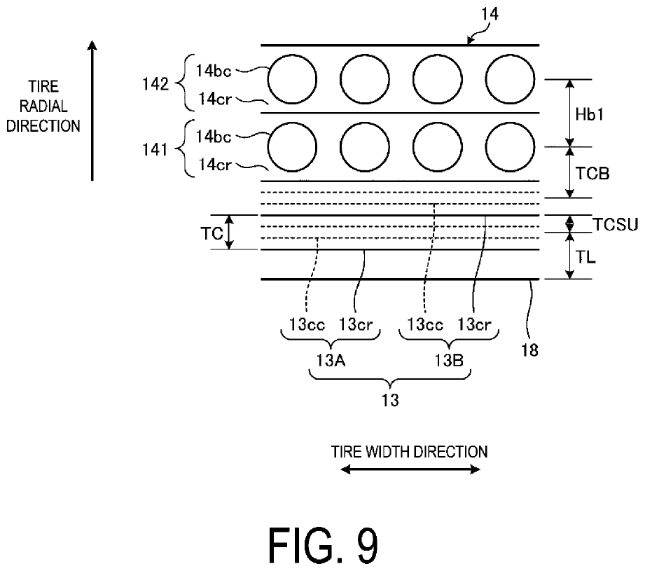

In the configuration of FIG. 1, as illustrated in FIG. 8, the carcass layer 13 includes the single carcass ply 13A formed by covering a carcass cord 13cc with a coating rubber 13cr, and the belt layer 14 is formed of the pair of cross belts 141, 142 formed by covering belt cords 14bc with coating rubbers 14cr. Further, the innerliner 18 is disposed to cover the inner circumferential surface of the carcass layer 13. However, no such limitation is intended, and the carcass layer 13 may be formed of two carcass plies (see FIG. 9 described below).

In FIG. 8, a distance TL (mm) from the center of the outer diameter of the carcass cord 13cc of the carcass ply 13A (carcass ply of the innermost layer in the configuration where the carcass layer 13 is formed of the two carcass plies (not illustrated)) to the tire inner surface in a region between the points B2, B2 in FIG. 4 with respect to the tire outer diameter OD (mm) (see FIG. 1) is in the range 0.00005≤TL/OD≤0.01000 and preferably in the range 0.00008≤TL/OD≤0.00900. The distance TL (mm) with respect to the total tire width SW (mm) (see FIG. 1) is in the range 0.00050≤TL/SW≤0.02500 and preferably in the range 0.00060≤TL/SW≤0.02300. The lower limit appropriately suppresses an air leakage, and the upper limit suppresses the increase in tire weight. A minimum value Tl_min of the distance TL (mm) is preferably 0.10≤TL_min. The minimum value TL_min and the maximum value TL_max of the distance TL (mm) in the region between the points B2 and B2 in FIG. 4 have the relationship 0.30≤TL_min/TL_max≤1.00, and preferably have the relationship 0.40≤TL_min/TL_max≤1.00. This uniformly sets the distance TL from the carcass cord 13cc to the tire inner surface in the region.

The distance TL (mm) is defined as a discretionary measurement point in the region between the two points B2 and B2 (see FIG. 4).

Further, the distance TL (mm) with respect to the total tire width SW (mm), the tire outer diameter OD (mm), and the rim diameter RD (mm) (see FIG. 1) is in the range 1/350000≤TL/(SW×(OD-RD))≤1/3760.

In FIG. 8, a distance TCSU (mm) from the center of the carcass cord 13cc of the carcass ply 13A (carcass ply of the innermost layer in the configuration where the carcass layer 13 is formed of the two carcass plies (not illustrated)) to the outer surface of the carcass ply 13A of the innermost layer at a discretionary point in the region between the points B2, B2 in FIG. 4 with respect to the distance TL (mm) from the center of the carcass cord 13cc of the carcass ply 13A of the innermost layer to the tire inner surface is in the range 0.09≤TCSU/TL≤4.50 and preferably in the range 0.10≤TCSU/TL≤4.00. The lower limit appropriately suppresses an air leakage, and the upper limit suppresses the increase in tire weight.

In FIG. 8, a modulus MC (MPa) at 100% elongation of the coating rubber 13cr of the carcass ply 13A with respect to a modulus MIL (MPa) at 100% elongation of the innerliner 18 and a modulus MB (MPa) at 100% elongation of the coating rubber 14cr of the belt ply 141 of the innermost layer of the belt layer 14 is in the range MIL≤MC≤MB. A ratio MC/MIL is in the range 1.00≤MC/MIL≤5.00 and preferably in the range 1.10≤MC/MIL≤4.50. A ratio MB/MC is in the range 1.00≤MB/MC≤2.40 and preferably in the range 1.00≤MB/MC≤2.20. The modulus MC (MPa) of the coating rubber 13cr of the carcass ply 13A is in the range 1.5≤MC≤12.0 and preferably in the range 2.0≤MC≤10.0. This properly suppresses an air leakage and ensures the durability performance of the tire.

In FIG. 8, a product of a thicknesses TC (mm) of the carcass ply 13A and a loss tangent tan 8 at 60 °C of the coating rubber 13cr of the carcass ply 13A is in the range 0.05≤TC×tand≤0.55 and preferably in the range 0.07≤TC×tan δ≤0.50. This properly suppresses the heat generation of the carcass layer 13 and ensures the durability performance of the tire.

FIG. 9 is an explanatory diagram illustrating a modified example of the multilayer structure of the carcass layer 13 and the belt layer 14 illustrated in FIG. 8.

In the configuration of FIG. 8, the carcass layer 13 is formed of the single carcass ply 13A as described above. For example, it is assumed that the carcass cord 13cc of the carcass ply 13A consists of inorganic fiber, in particular, a steel cord.

However, no such limitation is intended, and as illustrated in FIG. 9, the carcass layer 13 may have a structure formed of the two carcass plies 13A, 13B. For example, it is assumed that the carcass cords 13cc of the carcass plies 13A, 13B are made of an organic fiber material. In such a configuration, a peel strength Hpp (N/25 mm) per width of 25 mm between the carcass ply 13B of the outermost layer of the carcass layer 13 and the belt ply of the innermost layer of the belt layer 14 (the radially inner cross belt 141 in FIG. 9) with respect to a distance TCB (mm) from the center of the outer diameter of the carcass cord 13cc of the carcass ply 13B to the center of the outer diameter of the belt cord 14bc of the belt ply 141 is in the range 90≤Hpp/TCB≤300 and preferably in the range 100≤Hpp/TCB≤250. The peel strength Hpp (N/25 mm) with respect to the number of insertions Ecs (cord/50 mm) of the carcass cords 13cc of the carcass plies is in the range 1.50≤Hpp/Ecs≤15.0 and preferably in the range 1.80≤Hpp/Ecs≤10.0. This ensures the durability of the tire.

A test sample having a rectangular shape elongated in the extension direction of the carcass cord, a width of 25 mm, and a length of 100 mm or more (preferably, a length of 150 mm or more including a test tong hold of about 50 mm) is used and the peel strength Hpp (N/25 mm) is calculated as an average value of the maximum value and the minimum value of peak values of an analyzed wavy curve. The number of test samples is preferably 2 or more.

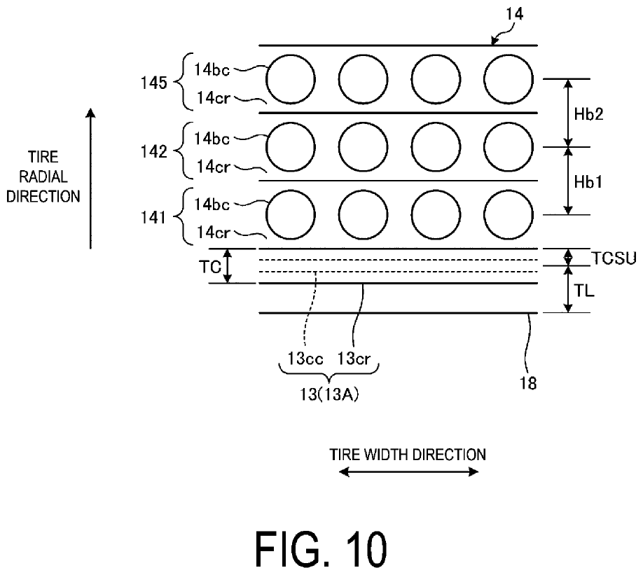

FIG. 10 is an explanatory diagram illustrating a modified example of the multilayer structure of the carcass layer 13 and the belt layer 14 illustrated in FIG. 8.

In the configuration of FIG. 1, as described above, the belt layer 14 includes the pair of cross belts 141, 142, the belt cover 143, and the pair of belt edge covers 144, 144. As illustrated in FIG. 8, the pair of cross belts 141, 142 is layered adjacent to the outer circumferential surface of the carcass layer 13.

In contrast, in the configuration of FIG. 10, the belt layer 14 includes a supplemental belt 145 that is a third cross belt. The supplemental belt 145 is layered on the outer circumference of the pair of cross belts 141, 142.

In FIG. 10, inter-cord distances Hb of adjacent belt plies of the pair of cross belts 141, 142 and the supplemental belt 145 (an inter-cord distance Hb1 between cords of the pair of cross belts 141, 142 and an inter-cord distance Hb2 between the radially outer cross belt 142 and the supplemental belt 145 in FIG. 10) are defined. At this time, an inter-cord distance Hb_sh (not illustrated) at end portions of at least one set of belt plies with respect to an inter-cord distance Hb_ce (not illustrated) in the tire equatorial plane CL is in the range 1.05≤Hb_sh/Hb_ce≤2.00 and preferably in the range 1.50≤Hb_sh/Hb_ce≤1.80. Therefore, the inter-cord distance Hb is preferably set to large in the tread portion center region. The lower limit allows effectively obtaining the suppression effect of the tire outer diameter growth by the belt layer 14, and the upper limit ensures the durability of the belt layer. The above-described configuration is achieved by, for example, a configuration in which the gauge of the coating rubber of the belt ply is increased in the tread portion center region and a configuration in which a supplemental rubber sheet is inserted between adjacent belt plies (not illustrated).

### Region on Outer Side in Tire Radial Direction

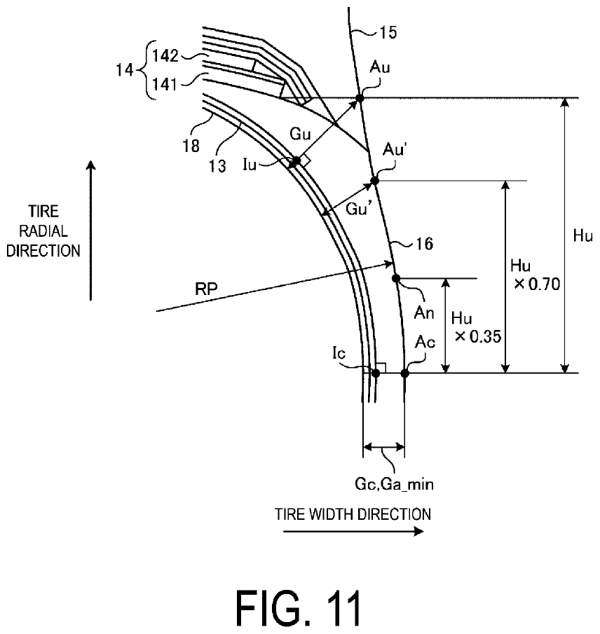

FIG. 11 is an enlarged view illustrating a region on an outer side in the tire radial direction illustrated in FIG. 6.

In FIG. 11, a point An on the side profile at a radial position of 35% of the above-described distance Hl from the tire maximum width position Ac is defined. The point An corresponds to a midpoint between the tire maximum width position Ac and the above-described point Au′ on the side profile in the tire radial direction.

At this time, a radius of curvature RP (mm) of an arc passing through the tire maximum width position Ac, the point Au′, and the point An when the tire is mounted on a specified rim, inflated to a specified internal pressure, and in an unloaded state with respect to the tire cross-sectional height SH (mm) (see FIG. 2) is in the range 0.20≤RP/SH≤1.80 and preferably in the range 0.70≤RP/SH≤1.60. The radius of curvature RP (mm) of the arc in the unloaded state is in the range 30≤RP≤250 and preferably in the range 50≤RP≤200.

For example, in the configuration of FIG. 11, the side profile has a gentle S-shape having a single inflection point (not illustrated) in a region from the tire maximum width position Ac to the point Au in the vicinity of an end portion of the innermost layer 141 of the belt layer 14 (a region of the distance Hu), and has a shape that is convex toward a tire outer side in a region on the tire maximum width position Ac side from the inflection point and convex toward a tire inner side in a region on the buttress portion side. The inflection point of the S-shape is located in the vicinity of the point Au′ located at a radial position of 70[%] of the distance Hu. Therefore, the side profile has a substantially arc shape that is convex toward the tire outer side in the region from the tire maximum width position Ac to the point Au′. Therefore, the arc that defines the radius of curvature RP (mm) has a shape that is convex toward the tire outer side.

In the configuration described above, the radius of curvature RP of the side profile in the region on the outer side in the tire radial direction from the tire side portion to the buttress portion is properly set and thus the ground contact performance and durability performance of the tire are provided in a compatible manner and the load capacity of the tire is appropriately ensured. Specifically, the lower limit of the ratio RP/SH reduces the amount of deflection of the region on the outer side in the tire radial direction during rolling of the tire and suppresses the ground contact length of the tread portion shoulder region from becoming excessively long. This properly sets a contact patch shape of the tire, ensuring the ground contact performance (particularly, noise performance) of the tire. The upper limit of the ratio RP/SH alleviates stress concentration caused by the region on the outer side in the tire radial direction becoming flat, improving the durability performance of the tire. In particular, for a small-diameter tire, since the tire is used under the above-described high load, a ground contact length of a tread portion shoulder region becomes long, and a large stress tends to act on the tire side portion. Therefore, by adopting the above-described configuration for the small-diameter tire, the effect of improving the ground contact performance and durability performance of the tire is significantly obtained.

In FIG. 11, the radius of curvature RP (mm) of the arc with respect to the tire cross-sectional width DW (mm) and the tire cross-sectional height SH (mm) is in the range 60≤RP/(SH/DW)≤290 and preferably in the range 150≤RP/(SH/DW)≤250. As a result, the radius of curvature RP (mm) of the arc is properly set with respect to the aspect ratio SH/DW of the tire 1. Specifically, the lower limit reduces the amount of deflection of the region on the outer side in the tire radial direction during rolling of the tire, ensuring the durability performance of the tire. The upper limit alleviates stress concentration in the region on the outer side in the tire radial direction, improving the durability performance of the tire.

In FIG. 11, a radius of curvature RP′ (mm) (dimension symbol omitted in the drawing) of the arc when the tire is mounted on a specified rim and inflated to a specified internal pressure and a load of 100% of a specified load is applied is defined. In other words, the tire maximum width position Ac, the point Au′, and the point An are defined in the unloaded state described above, and then the radius of curvature RP′ (mm) of the arc passing through the three points Ac, Au′, and An (not illustrated) displaced due to the application of the load of 100% of the specified load is defined. At this time, the radius of curvature RP (mm) of the arc in the unloaded state described above with respect to the radius of curvature RP′ (mm) of the arc when the load of 100% of the specified load is applied is in the range 1.10≤RP/RP′≤2.80 and preferably in the range 1.15≤RP/RP′≤2.60. As a result, the radius of curvature RP′ when the load of 100% is applied is properly set. Specifically, the lower limit ensures the amount of deflection of the region on the outer side in the tire radial direction when the load is applied, that is, when the load increases, and alleviates stress concentration in the region on the outer side in the tire radial direction. The upper limit reduces the amount of deflection of the region on the outer side in the tire radial direction during rolling of the tire, ensuring the durability performance of the tire.

In FIG. 11, a radius of curvature RP″ (mm) (dimension symbol omitted in the drawing) of the arc when the tire is mounted on a specified rim and inflated to a specified internal pressure and a load of 150% of a specified load is applied is defined. In other words, the radius of curvature RP″ (mm) of the arc passing through the three points Ac, Au′, and An (not illustrated) displaced due to the application of the load of 150% of the specified load is defined. At this time, the radius of curvature RP′ (mm) of the arc when the load of 100% is applied with respect to the radius of curvature RP″ (mm) of the arc when the load of 150% of the specified load is applied is in the range 1.01≤RP′/RP″≤1.50 and preferably in the range 1.05≤RP′/RP″≤1.30. As a result, the radius of curvature RP″ when the load of 150% is applied, that is, when under a high load, is properly set. Specifically, the lower limit ensures the amount of deflection of the region on the outer side in the tire radial direction during use under a high load and alleviates stress concentration in the region on the outer side in the tire radial direction. The upper limit reduces the amount of deflection of the region on the outer side in the tire radial direction during rolling of the tire, that is, the amount of repeated deformation, and ensures the durability performance of the tire.

As described above, the belt layer 14 includes the pair of cross belts 141, 142 having cord angles having mutually opposite reference signs (see FIG. 3). The cord angles Bθ (Bθ1, Bθ2) of the pair of cross belts 141, 142 are in the range of 15 degrees or more and 55 degrees or less as an absolute value, and preferably in the range of 15 degrees or more and 35 degrees or less. At this time, each of the cord angles Bθ (degree) of the pair of cross belts 141, 142 with respect to the radius of curvature RP (mm) of the arc of the region on the outer side in the tire radial direction is in the range of 1000≤Bθ×RP≤7700 and preferably in the range of 1200≤Bθ×RP≤7500. Thus, the product Bθ×RP is properly set. Specifically, the lower limit of the product Bθ×RP suppresses the ground contact length of the tread portion shoulder region from becoming excessively long, ensuring the ground contact performance (in particular, noise performance) of the tire. The upper limit of the product Bθ×RP ensures the hoop effect by the cross belts 141, 142 and alleviates stress concentration in the region on the outer side in the tire radial direction, improving the durability performance of the tire.

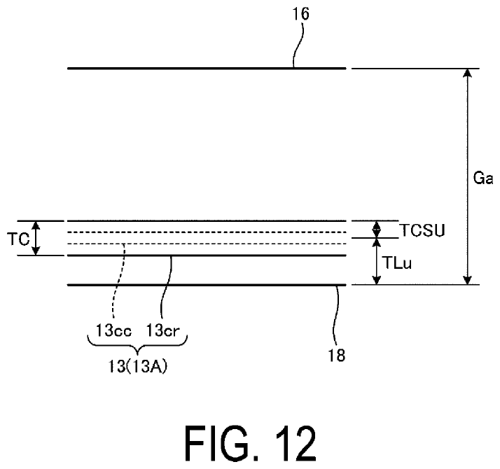

FIG. 12 is an explanatory diagram illustrating a multilayer structure of the carcass layer 13 and the innerliner 18 in the region on the outer side in the tire radial direction illustrated in FIG. 11.

In FIG. 11, a foot of a perpendicular line drawn from the point Au on the side profile at the same position in the tire radial direction with respect to an end portion of the innermost layer 141 of the belt layer 14 to the carcass layer 13 is defined as a point Iu. A foot of a perpendicular line drawn from the tire maximum width position Ac to the carcass layer 13 is defined as a point Ic. As shown in FIG. 11, the points Iu and Ic match the measurement positions of the total gauges Gu and Gc, respectively.

In FIG. 12, as described above, the carcass layer 13 is formed by covering the carcass cord 13cc with the coating rubber 13cr. In the configuration of FIG. 12, the carcass layer 13 is formed of the single carcass ply 13A. However, no such limitation is intended, and the carcass layer 13 may be composed of a plurality of carcass plies (see FIG. 9).

In this case, a distance TLu (mm) (see FIG. 12) from the center of the carcass cord 13cc of the innermost layer 13A of the carcass ply 13A (carcass ply of the innermost layer in the configuration (not illustrated) in which the carcass layer 13 is formed by layering two carcass plies) to the tire inner surface in a region from the point Iu to the point Ic in FIG. 11 with respect to the tire outer diameter OD (mm) is in the range 0.00010≤TLu/OD≤0.01500 and preferably in the range 0.00015≤TLu/OD≤0.01200. Specifically, for example, in a configuration in which the innerliner 18 is made of a rubber composition containing butyl rubber as a main component, the ratio TLu/OD is in the range 0.00090≤TLu/OD≤0.01500, and preferably in the range 0.00100≤TLu/OD≤0.01200. In a configuration in which the innerliner 18 is made of a thermoplastic resin or a thermoplastic elastomer composition in which an elastomer component is blended in a thermoplastic resin, the ratio TLu/OD is in the range 0.00010≤TLu/OD≤0.00200, and preferably in the range 0.00015≤TLu/OD≤0.00100.

In the above-described configuration, the distance TLu from the carcass layer 13 to the tire inner surface in the region from the end portion of the belt layer 14 to the tire maximum width position Ac is properly set. Specifically, the lower limit ensures the distance TLu from the carcass layer 13 to the tire inner surface in the region in which air leakage is likely to occur, and suppresses a deterioration of the durability performance and a deterioration of the rolling resistance of the tire due to air leakage. The upper limit suppresses a deterioration of the rolling resistance caused by the increase in tire weight. This provides the durability performance and the low rolling resistance performance of the tire in a compatible manner. In particular, for a small-diameter tire, since the tire is used under the high internal pressure and the high load described above, stress concentration tends to occur. Therefore, by adopting the above-described configuration for the small-diameter tire, the effect of improving the durability performance and low rolling resistance performance of the tire is significantly obtained.

A minimum value TLu_min and a maximum value TLu_max of the distance TLu (mm) (see FIG. 12) in the region from the point Iu to the point Ic in FIG. 11 have the relationship 0.30≤TLu_min/TLu_max≤1.00, and preferably have the relationship 0.40≤TLu_min/TLu_max≤1.00. In such a configuration, since the distance TLu from the carcass cord 13cc to the tire inner surface is set to be uniform in the above-described region, tire failure due to non-uniformity of the distance TLu is suppressed, and the risk of occurrence of air leakage is reduced. The distance TLu (mm) is in the range 0.1≤TLu≤4.0 and preferably in the range 0.5≤TLu≤3.5. The lower limit ensures the distance TLu from the carcass cord 13cc to the tire inner surface and appropriately suppresses air leakage, and the upper limit suppresses a deterioration of the rolling resistance caused by the increase in tire weight.

For example, in the configuration of FIG. 11, TLu_min/TLu_max<1.00, and a position where the distance TLu takes the maximum value TLu_max is located closer to the point Ic (i.e., closer to the tire maximum width position Ac) than a position where the distance TLu takes the minimum value TLu_min. The position where the distance TLu takes the maximum value TLu_max is in a region from the point Ic to 35% of the distance Hu in FIG. 11 (i.e., a region from the point Ac to the point An). The position where the distance TLu takes the minimum value TLu_min is in a region from the point Iu to 35% of the distance Hu in FIG. 11. Further, the distance TLu monotonically increases from the position where it takes the minimum value TLu_min toward the position where it takes the maximum value TLu max.

A minimum value Ga_min (see FIG. 11) of the total gauge Ga (mm) of the tire side portion in a region from the point Iu to the point Ic in FIG. 11 and a distance TLu′(mm) (dimension symbol omitted in the drawing) corresponding to the distance TLu at the same position have the relationship 0.05≤TLu′/Ga_min, and preferably the relationship 0.10≤TLu′/Ga_min (see FIG. 12). This ensures the distance TLu′ from the carcass cord 13cc to the tire inner surface at a position where the total gauge Ga is thin and appropriately suppresses air leakage. In the configuration of FIG. 11, the total gauge Ga of the tire side portion becomes minimum at the tire maximum width position Ac, and therefore the minimum value Ga_min matches the total gauge Gc. The distance TLu′ is measured at the tire maximum width position Ac where the total gauge Ga takes the minimum value Ga_min. The upper limit of the ratio TLu′/Ga_min is not particularly limited, but is restricted by the upper limit of the distance TLu.

The minimum Ga_min of the total gauge Ga (mm) of the tire side portion in the region from the point Iu to the point Ic in FIG. 11 and the distance TLu′ (mm) corresponding to the distance TLu at the same position with respect to the tire outer diameter OD (mm) are in the range 0.005≤(Ga_min+TLu′)/OD≤0.040 and preferably in the range 0.006≤(Ga_min+TLu′)/OD≤0.030. The lower limit appropriately suppresses an air leakage, and the upper limit suppresses the increase in tire weight.

The distance TLu (mm) in the region from the point Iu to the point Ic in FIG. 11 with respect to an oxygen permeability coefficient a (mm. cc/(m\hat{ }2·day·mmHg)) of the innerliner 18 has the relationship 0.005≤(α\hat{ }(1/2))/TLu≤1.800 and preferably has the relationship 0.008≤(α\hat{ }(1/2))/TLu≤1.500. The oxygen permeability coefficient α of the innerliner 18 is in the range 0.0008≤α≤0.3500, and preferably in the range 0.0010≤α≤0.3000. This can improve the crack resistance of the innerliner 18 is secured, and the internal pressure holding property against air leakage.

The oxygen permeability coefficient a is an index indicating how much oxygen permeates through the material constituting the innerliner 18, and is measured at a relative temperature of 21 °C and a relative humidity of 50% in accordance with JIS K7126.

A dynamic storage elastic modulus β (MPa) of the innerliner 18 is in the range 1≤β≤200, and preferably in the range 2≤β≤150. This can improve the crack resistance of the innerliner 18 is secured, and the internal pressure holding property against air leakage.

The dynamic storage elastic modulus β is measured using a viscoelastic spectrometer available from Toyo Seiki Seisaku-sho, Ltd., with a sample piece cut into a strip shape of 5 mm in width and 60 mm in length, under conditions of a static strain of 5%, a dynamic strain of ±0.1%, a frequency of 20 Hz, and a temperature of 60 °C.

In the innerliner 18, in order to suppress air leakage, the end portions of the constituent members thereof are connected to overlap each other. In this case, a splice amount Is (mm) (not shown) of the innerliner 18 in the region from the point Iu to the point Ic in FIG. 11, that is, an overlap width of the end portions of the constituent members with respect to the tire outer diameter OD (mm) is in the range 0.010≤Is/OD≤0.100, and preferably in the range 0.015≤Is/OD≤0.080. The splice amount Is (mm) of the innerliner 18 is in the range 8≤Is≤20. The lower limit appropriately suppresses an air leakage, and the upper limit suppresses the deterioration of the rolling resistance caused by the increase in tire weight.

In FIG. 4, as described above, the feet of perpendicular lines drawn from the left and right tire ground contact edges T, T to the carcass layer 13 are defined as the points B2, B2, respectively. The minimum TL_min of the distance TL (mm) (see FIG. 8) from the center of the carcass cord 13cc of the innermost layer 13A of the carcass ply to the tire inner surface in the region between the points B2 and B2 is defined.

In this case, the minimum TLu_min of the distance TLu (mm) (see FIG. 12) in the region from the point Iu to the point Ic in FIG. 11 with respect to the minimum TL_min of the distance TL (mm) in the region between the points B2 and B2 in FIG. 4 is in the range 1.00≤TLu_min/TL_min, and preferably in the range 1.05≤TLu_min/TL_min. Therefore, the distance TLu in the region from the point Iu to the point Ic is set such that the distance from the carcass ply to the tire inner surface does not become relatively thin in the region where air leakage is likely to occur. This relatively ensure the distance TL from the carcass ply to the tire inner surface in the region from the point Iu to the point Ic where air leakage is likely to occur and effectively suppresses air leakage.

### Effect

(1) As described above, the tire 1 includes the pair of bead cores 11, 11, the carcass layer 13 extending between the pair of bead cores 11, 11, and the belt layer 14 disposed on the outer side of the carcass layer 13 in the radial direction (see FIG. 1). The tire outer diameter OD (mm) is in the range 200≤OD≤660, and the total tire width SW (mm) is in the range 100≤SW≤400. In the cross-sectional view in the tire meridian direction, the point Au on the side profile at the same position in the tire radial direction with respect to an end portion of the innermost layer 141 of the belt layer 14 is defined. The foot of a perpendicular line drawn from the point Au to the carcass layer 13 is defined as the point Iu, and the foot of a perpendicular line drawn from the tire maximum width position Ac to the carcass layer is defined as the point Ic. The carcass layer 13 is composed of a single carcass ply (see FIG. 8) or a plurality of carcass plies (see FIG. 9) formed by covering the carcass cord 13cc with the coating rubber 13cr. The distance TLu (mm) (see FIG. 12) from the center of the carcass cord 13cc of the innermost layer 13A of the carcass ply to the tire inner surface in the region from the point Iu to the point Ic with respect to the tire outer diameter OD (mm) (see FIG. 1) is in the range 0.00010≤TLu/OD≤0.01500.

Such a configuration has an advantage that the distance TLu from the carcass layer 13 to the tire inner surface in the region from the end portion of the belt layer 14 to the tire maximum width position Ac is properly set. Specifically, the lower limit ensures the distance TLu from the carcass layer 13 to the tire inner surface in the region in which air leakage is likely to occur, and suppresses a deterioration of the durability performance and a deterioration of the rolling resistance of the tire due to air leakage. The upper limit suppresses a deterioration of the rolling resistance caused by the increase in tire weight. This provides the durability performance and the low rolling resistance performance of the tire in a compatible manner. In particular, for a small-diameter tire, since the tire is used under the high internal pressure and the high load described above, stress concentration tends to occur. Therefore, by adopting the above-described configuration for the small-diameter tire, the effect of improving the durability performance and low rolling resistance performance of the tire is significantly obtained.

(2) In the tire 1 that is the tire 1 of (1) described above, the minimum value TLu_min and the maximum value TLu_max of the distance TLu (mm) (see FIG. 12) in the region from the point Iu to the point Ic have the relationship 0.30≤TLu_min/TLu_max≤1.00. In such a configuration, since the distance TLu from the carcass cord 13cc to the tire inner surface is set to be uniform in the above-described region, tire failure due to non-uniformity of the distance TLu is suppressed, and the risk of occurrence of air leakage is reduced.

(3) In the tire 1 that is the tire 1 of (1) or (2) described above, the distance TLu (mm) in the region from the point Iu to the point Ic is in the range 0.1≤TLu≤4.0. There is an advantage that the lower limit ensures the distance TLu from the carcass cord 13cc to the tire inner surface and appropriately suppresses air leakage, and the upper limit suppresses a deterioration of the rolling resistance caused by the increase in tire weight.

(4) In the tire 1 that is the tire 1 of any one of (1) to (3) described above, the total gauge Ga (mm) of the tire side portion in the region from the point Iu to the point Ic (see FIG. 11) and the distance TLu′ (mm) corresponding to the distance TLu at the same position have the relationship 0.05≤TLu′/Ga_min (see FIG. 12). This has an advantage that the distance TLu′ from the carcass cord 13cc to the tire inner surface at a position where the total gauge Ga is thin is ensured and that air leakage is appropriately suppressed.

(5) In the tire 1 that is the tire 1 of any one of (1) to (4) described above, the distance TLu (mm) in the region from point Iu to point Ic with respect to the oxygen permeability coefficient α (mm·cc/(m\hat{ }2·day mmHg)) of the innerliner 18 has the relationship 0.005≤(α\hat{ }(1/2))/TLu≤1.800. This has an advantage of being able to improve the internal pressure holding property against air leakage while having the crack resistance of the innerliner 18.

(6) In the tire 1 that is the tire 1 of any one of (1) to (5) described above, the splice amount Is (mm) (not shown) of the innerliner 18 in the region from the point Iu to the point Ic with respect to the tire outer diameter OD (mm) is in the range 0.01≤Is/OD≤0.10. There is an advantage that the lower limit appropriately suppresses an air leakage, and the upper limit suppresses the deterioration of the rolling resistance caused by the increase in tire weight.

(7) In the tire 1 that is the tire 1 of any one of (1) to (6) described above, feet of perpendicular lines drawn from the left and right tire ground contact edges T and T to the carcass layer 13 are defined as the points B2 and B2 (see FIG. 4). The minimum TLu_min of the distance TLu (mm) (see FIG. 12) in the region from the point Iu to the point Ic with respect to the minimum TL_min of the distance TL (mm) (see FIG. 8) from the center of the carcass cord 13cc of the innermost layer 13A of the carcass ply to the tire inner surface in the region between the points B2 and B2 is in the range 1.00≤TLu_min/TL_min. This has an advantage that the distance TL from the carcass ply to the tire inner surface in the region from the point Iu to the point Ic where air leakage is likely to occur is relatively ensured and that air leakage is effectively suppressed.

(8) In the tire 1 that is the tire 1 of any one of (1) to (7) described above, the tensile strength Tcs (N/ 50 mm) per a width of 50 mm of the carcass ply constituting the carcass layer 13 with respect to the tire outer diameter OD (mm) is in the range 17≤Tcs/OD≤120. Such a configuration appropriately ensures the load capacity of the carcass layer 13 in the small-diameter tire and has an advantage of providing the durability performance and the low rolling resistance performance of the tire in a compatible manner. Specifically, the lower limit suppresses tire deformation during use under a high load and ensures the durability performance of the tire. The use under a high internal pressure is possible, and the rolling resistance of the tire is reduced. In particular, since the small-diameter tire is assumed to be used under a high internal pressure and a high load, the durability performance and the reduction effect of the rolling resistance of the tire described above are significantly obtained. The upper limit suppresses the deterioration of the rolling resistance caused by the increase in the weight of the carcass layer.

(9) In the tire 1 that is the tire 1 of (8) described above, the carcass ply of the carcass layer 13 is configured by covering the carcass cord made of steel with a coating rubber. The cord diameter φcs (mm) of the carcass cord is in the range 0.15≤φcs≤1.10. The number of insertions Ecs (cord/ 50 mm) of the carcass cords is in the range 25≤Ecs≤80. This has an advantage that the above-described tensile strength Tcs of the carcass layer 13 is achieved.

(10) In the tire 1 that is the tire 1 of (9) described above, the carcass cord is formed by intertwining a plurality of yarns, and a yarn diameter φcss (mm) of the carcass cord with respect to the cord diameter φcs (mm) of the carcass cord is in the range 0.30≤φcss/φcs≤0.90. This has an advantage that the above-described tensile strength Tcs of the carcass layer 13 is achieved.

(11) In the tire 1 that is the tire 1 of (8) described above, the carcass layer 13 is formed by layering a pair of carcass plies 13A, 13B (see FIG. 9).

The pair of carcass plies 13A, 13B are configured by covering the carcass cords 13cc made of an organic fiber material with the coating rubber 13cr. The cord diameter φcs (mm) (dimension symbol omitted in the drawings) of the carcass cord 13cc is in the range 0.60≤φcs≤0.90. The number of insertions Ecs (cord/50 mm) of the carcass cords 13cc is in the range 40≤Ecs≤70. This has an advantage that the above-described tensile strength Tcs of the carcass layer 13 is achieved.

(12) In the tire 1 that is the tire 1 of any one of (1) to (11) described above, the total gauge Gu (mm) of the tire side portion at the point Au on the side profile with respect to the tire outer diameter OD (mm) is in the range 0.010≤Gu/OD≤0.080. This has an advantage that the total gauge Gu in the region on the outer side of the tire side portion in the radial direction is properly set. Specifically, the lower limit ensures the total gauge Gu in the region on the outer side of the tire side portion in the radial direction, suppresses the tire deformation during use under a high load, and ensures the durability performance of the tire. In particular, since the small-diameter tire is assumed to be used under a high internal pressure and a high load, the durability performance of the tire is significantly obtained. The upper limit suppresses the deterioration of the rolling resistance of the tire caused by the total gauge Gu being excessive.

### Example

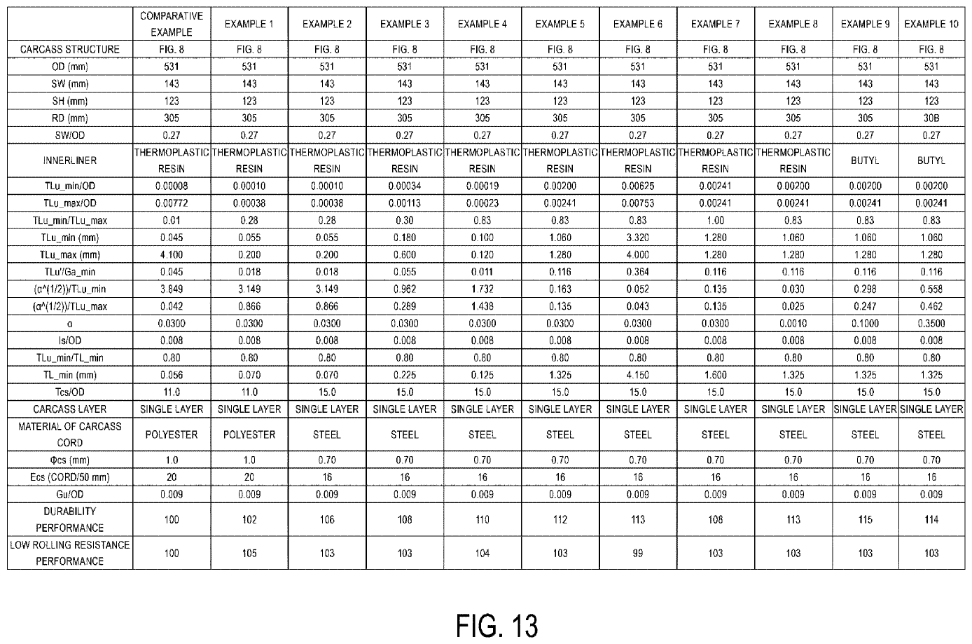

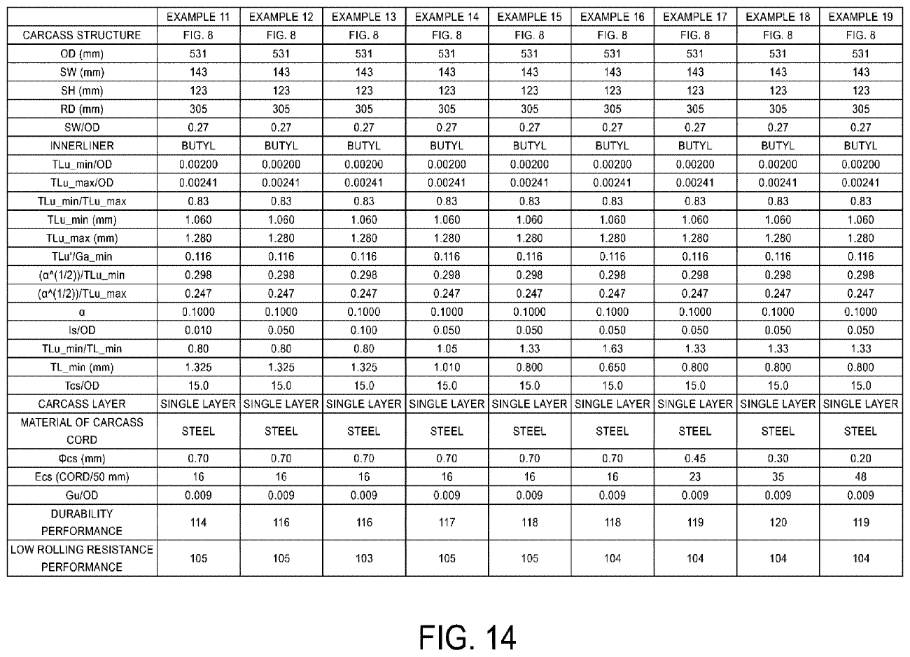

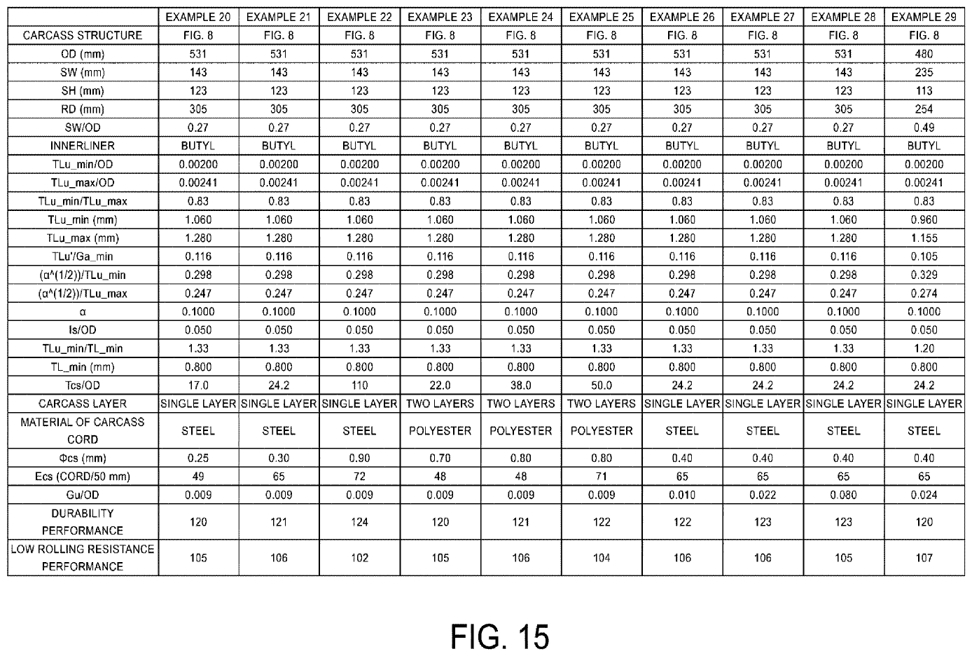

FIGS. 13 to 15 are tables showing results of performance tests of tires according to embodiments of the technology.

In the performance tests, (1) durability performance and (2) low rolling resistance performance (fuel consumption rate) were evaluated for a plurality of types of test tires. As an example of the small-diameter tire, test tires having two types of tire sizes are used. Specifically, [A] a test tire having a tire size of 145/80R12 is mounted on a rim having a rim size of 12×4.00B, and [B] a test tire having a tire size of 235/45R10 is mounted on a rim having a rim size of 10.

(1) In the evaluation on durability performance, an indoor drum testing machine having a drum diameter of 1707 mm is used, and an internal pressure of 80% of the specified internal pressure of JATMA and a load of 88% of the specified load of JATMA are applied to the test tire. The travel distance until tire failure is measured while increasing the load by 13% every 2 hours at the travel speed of 81 km/h. Then, the measurement results were expressed as index values and evaluated, with Comparative Example being assigned as the reference (100). In this evaluation, larger values are preferable.

(2) In the evaluation on low rolling resistance performance, an internal pressure of 80% of the specified internal pressure of JATMA and a load of 80% of the specified load of JATMA are applied to the test tire. A four-wheeled low-floor vehicle equipped with the test tires on all wheels travels 50 rounds on a test course having a total length of 2 (km) at a speed of 100 (km/h). Thereafter, the fuel consumption rate (km/l) is calculated and evaluated. The evaluation is expressed as index values and evaluated, with Comparative Example being assigned as the reference (100). In the evaluation, larger values are preferable as the fuel consumption rate is smaller and the rolling resistance tends to decrease. When the evaluation is 98 or more, it can be said that the low rolling resistance performance is appropriately secured.

The test tires 1 to 29 of Examples have the structure illustrated, in particular, in FIGS. 1 to 3 and FIG. 8, and include the pair of bead cores 11, 11, the carcass layer 13 formed of a single carcass ply, the pair of cross belts 141, 142, the belt layer 14 formed of the belt cover 143 and the pair of belt edge covers 144, 144, the tread rubber 15, the sidewall rubber 16, and the rim cushion rubber 17. In the test tire of Example 1, the tire outer diameter OD is 531 mm, the total tire width SW and the tire cross-sectional width DW are 143 mm, the tire cross-sectional height SH is 123 mm, and the tire inner diameter is 305 mm. The innerliner 18 is made of a rubber composition containing butyl rubber as a main component or a thermoplastic resin.

In the test tire of Comparative Example, the distance TLu (mm) (see FIG. 12) from the center of the carcass cord 13cc of the innermost layer 13A of the carcass ply to the tire inner surface in the region from the point Iu to the point Ic is set to be small in the test tire of Example 1.

As can be seen from the test results, the test tires of Examples provide the durability performance and low rolling resistance of the tire in a compatible manner.

1. A tire, comprising:
a pair of bead cores;
a carcass layer extending between the bead cores;
a belt layer disposed on an outer side of the carcass layer in a radial direction; and
an innerliner disposed on an inner surface of the carcass layer;
a tire outer diameter OD (mm) being in a range 200≤OD≤660,
a total tire width SW (mm) being in a range 100≤SW≤400,
in a cross-sectional view in a tire meridian direction, a point Au on a side profile at a position in a tire radial direction identical to an end portion of an innermost layer of the belt layer being defined, a foot of a perpendicular line drawn from the point Au to the carcass layer being defined as a point Iu, and a foot of a perpendicular line drawn from a tire maximum width position Ac to the carcass layer being defined as a point Ic,
the carcass layer being composed of a single carcass ply or a plurality of carcass plies formed by covering a carcass cord with a coating rubber, and
a distance TLu (mm) from a center of the carcass cord of an innermost layer of the carcass ply to a tire inner surface in a region from the point Iu to the point Ic with respect to the tire outer diameter OD (mm) being in a range 0.00010≤TLu/OD≤0.01500.

2. The tire according to claim 1, wherein a minimum value TLu_min and a maximum value TLu_max of the distance TLu (mm) in the region from the point Iu to the point Ic have a relationship 0.30≤TLu_min/TLu_max≤1.00.

3. The tire according to claim 1, wherein the distance TLu (mm) in the region from the point Iu to the point Ic is in a range 0.1≤TLu≤4.0.

4. The tire according to claim 1, wherein a minimum value Ga_min of a total gauge Ga (mm) of a tire side portion in the region from the point Iu to the point Ic and a distance TLu′ (mm) corresponding to the distance TLu at the same position have a relationship 0.05≤TLu′/Ga_min.

5. The tire according to claim 1, wherein the distance TLu (mm) in the region from the point Iu to the point Ic with respect to an oxygen permeability coefficient α (mm·cc/(m\hat{ }2·day·mmHg)) of the innerliner has a relationship 0.005≤(α\hat{ }(1/2))/TLu≤1.800.

6. The tire according to claim 1, wherein a splice amount Is (mm) of the innerliner in the region from the point Iu to the point Ic with respect to the tire outer diameter OD (mm) is in a range 0.01≤Is/OD≤0.10.

7. The tire according to claim 1, wherein
feet of perpendicular lines drawn from left and right tire ground contact edges to the carcass layer are defined as points B2 and B2, and
a minimum value TLu_min of the distance TLu (mm) in the region from the point Iu to the point Ic with respect to a minimum value TL_min of a distance TL (mm) from a center of the carcass cord of the innermost layer of the carcass ply to the tire inner surface in a region between the points B2 and B2 is in a range 1.00≤TLu_min/TL_min.

8. The tire according to claim 1, wherein a tensile strength Tcs (N/50 mm) per a width of 50 mm of a carcass ply constituting the carcass layer with respect to the tire outer diameter OD (mm) is in a range 17≤Tcs/OD≤120.

9. The tire according to claim 8, wherein
the carcass ply of the carcass layer is configured by covering a carcass cord made of steel with a coating rubber,
a cord diameter φcs (mm) of the carcass cord is in a range 0.15≤φcs≤1.10, and
the number of insertions Ecs (cord/50 mm) of the carcass cord is in a range 25≤Ecs≤80.

10. The tire according to claim 9, wherein
the carcass cord is formed by intertwining a plurality of yarns, and
a yarn diameter φcss (mm) of the carcass cord with respect to the cord diameter φcs (mm) of the carcass cord is in a range 0.30≤φcss/φcs≤0.90.

11. The tire according to claim 8, wherein
the carcass layer is formed by layering a pair of carcass plies,
the pair of carcass plies is configured by covering a carcass cord made of an organic fiber material with a coating rubber,
the cord diameter φcs (mm) of the carcass cord is in a range 0.60≤φcs≤0.90, and
the number of insertions Ecs (cord/50 mm) of the carcass cord is in a range 40≤Ecs≤70.

12. The tire according to claim 1, wherein a total gauge Gu (mm) of a tire side portion at the point Au on the side profile with respect to the tire outer diameter OD (mm) is in a range 0.010≤Gu/OD≤0.080.
